(19) United States
(12) Patent Application Publication
(10) Pub. No.: US 2001/0039183 A1
(43) Pub. Date: Nov. 8, 2001

(54) Radio communication device, radio communication system and redio communication method

(76) Inventors: Tsugunao Kobayashi, Chiba (JP); Kunio Fukuda, Tokyo (JP)

Correspondence Address: JAY H. MAIOLI, Cooper & Dunham LLP, 1185 Avenue of the Americas, New York, NY, 10036, US

(21) Appl. No.: 09/779,218

(22) Filed: Feb. 7, 2001

(30) Foreign Application Priority Data
Feb. 9, 2000 (JP) P2000-038133
Mar. 9, 2000 (JP) P2000-071078

(51) Int. Cl. H04B 1/10

(52) U.S. Cl. 455/63; 455/423; 455/528

(57) ABSTRACT

A radio communication device, a radio communication system comprising a bases station and a plurality of terminal communication devices and a radio communication method that can reduce the risk of interfering with the operation of some other system using a same frequency band and also the risk of degrading its performance due the interference of some other system using a same frequency band. The radio communication system includes a base station and terminals adapted to radio communications using the ISMA method. The base station 10 comprises a packet detection circuit 14 for detecting a packet transmitted from a terminal, an interference wave detection circuit 15 for detecting a meteorological radar wave and an IS generating circuit 17 for generating an idle signal that informs the terminals of the idle state of the communication channel. Upon receiving the idles signal, any of the terminals transmits a packet to be transmitted to the outside. If the base station detects any interference wave found on the communication channel, it suspends the transmission of the idle signal until.

### BACKGROUND OF THE INVENTION

1. Field of the Invention

This invention relates to a radio communication device adapted to wireless data communications, to a radio communication system comprising a base station and one ore more than one terminal stations adapted to exchange data with each other for wireless data communications and also to a radio communication method to be suitably used for such a radio communication system.

2. Related Background Art

The ISMA (Idle Signal Multiple Access) method has been known as a radio communication method to be suitably used for radio communication systems comprising a base station and a plurality of terminals adapted to communicate with each other by means of radio frequencies (Society of Electronic Communications “Treatises 81/10, vol. J64-B No. 10, pp. 1107-1114”). With the ISMA method, the base station transmits an idle signal (to be referred to as IS signal hereinafter) to selected terminals so that only the terminals that received the IS signal can transmit a packet to the base station. The ISMA method provides the advantage of dissolving the problem of hidden terminals that arises with the CSMA (Carrier Sense Multiple Access) method.

Firstly, a known radio communication system using the ISMA method will be discussed below.

Referring to FIG. 1 of the accompanying drawings, the known radio communication system using the ISMA method comprises a single base station 101 and one ore more than one terminals 102 (102a through 102f). A single radio frequency band (communication channel) is assigned to the single base station 101 of the radio communication system using the ISMA method and, if the system comprises a plurality of terminals, the single communication channel is shared by them for radio communications. Radio communications takes place between the base station 101 and the terminals 102 in the radio communication system using the ISMA method. A signal transmission from the base station to any of the terminals is referred to as down link, whereas a signal transmission from any of the terminals to the base station is referred to as up link.

FIG. 2 of the accompanying drawings is a schematic block diagram of the base station 101 of the radio communication system.

Referring to FIG. 2, the base station 101 comprises an antenna 111, a reception circuit 112, a transmission circuit 113, a packet detection circuit 114, a packet assembling circuit 115, an IS generating circuit 116 and a switching circuit 117.

The antenna 111 is adapted to detect the radio wave of the communication channel to be used in the system for signal transmission/reception and also to transmit signals.

The reception circuit 112 is adapted to operations such as frequency conversion and demodulation to be conducted on the RF signal detected by the antenna 111.

The transmission circuit 113 is adapted to operations such as modulation of the data to be transmitted to terminals 102, frequency conversion and transmission of an RF signal by way of the antenna 111.

The packet detection circuit 114 is fed with the data received by the reception circuit 112 and determines by referring to the data if there is a terminal 102 or more than one terminals 102 transmitting a packet, using the communication channel assigned to the system. If it is determined that there is a single terminal 102 transmitting a packet, using the communication channel assigned to the system (and hence there are no plurality of terminals transmitting data simultaneously), the packet detection circuit 114 outputs the detected packet to the outside by way of an output interface as up link data.

The packet assembling circuit 115 assembles the down link data input from the outside by way of an input interface into a packet. Then, the packet assembling circuit 115 outputs the packet when it is determined that by the packet detection circuit 14 no other packet is being transmitted by any of the terminals 102, using the communication channel assigned to the system (and hence the communication channel is in an idle state).

The IS generating circuit 116 generates an IS signal. An IS signal is used to indicate that the communication channel is idle and any of the terminals 102 can use it to transmit a packet to the base station 101 by way of the communication channel. The IS generating circuit 116 outputs an IS signal at a timing when the packet detection circuit 114 is not using the communication channel and no terminal 102 is transmitting a packet and when no down link is taking place. The IS generating circuit 116 also generates an acknowledge signal for notifying the terminal 102 that sent out the packet of the fact that the packet has reached the base station 101 without problem. The IS generating circuit 116 sends out the IS signal with the acknowledge signal contained therein. An IS signal containing an acknowledge signal is referred to as ISA signal in order to discriminate it from an ordinary IS signal. An IS signal, an ISA signal and the timing of transmitting/receiving a packet will be discussed in greater detail hereinafter.

The switching circuit 117 is adapted to forward the packet fed from the packet assembling circuit 115 for down link and the IS signal or the ISA signal fed from the IS generating circuit 116 by way of its switching operations matched to their transmission timings so as to feed in the transmission circuit 113.

FIG. 3 is a schematic block diagram of a terminal 102 of the radio communication system.

The terminal 102 comprises an antenna 121, a reception circuit 122, a transmission circuit 123, an IS detection circuit 124, a packet detection circuit 125, a packet assembling circuit 126 and a packet transmission control circuit 127.

The antenna 121 is adapted to detect the radio wave of the communication channel to be used in the system for signal transmission/reception and also to transmit signals.

The reception circuit 122 is adapted to operations such as frequency conversion and demodulation to be conducted on the RF signal detected by the antenna 121.

The transmission circuit 123 is adapted to operations such as modulation of the data to be transmitted to the base station 101, frequency conversion and transmission of an RF signal by way of the antenna 121.

The IS detection circuit 124 detects the IS signal or the ISA signal transmitted from the base station 101.

The packet detection circuit 125 identifies the packet transmitted from the base station 101 and, if the received packet is sent from the base station 101 to the terminal 102 itself, outputs it to the outside by way of an output interface as down link data.

The packet assembling circuit 126 assembles the up link data input to it from the outside by way of an input interface into a packet.

The packet transmission control circuit 127 carries out operations such as scheduling the timing of transmitting the packet fed from the packet assembling circuit 126 and determining the probability of transmission of the packet. More specifically, when the IS detection circuit 124 detects an IS signal, the packet transmission control circuit 127 determines if the communication channel is available or not and, if it is determined that the communication channel is available, it transmits the packet immediately after the reception of the IS signal. At this time, the packet transmission control circuit 127 determines the probability of transmission of the packet and actually transmits the packet if the probability is not lower than ñ, but it does not if the probability is not higher than 1−ñ.

Additionally, after the transmission of the packet, the packet transmission control circuit 127 determines if an IS signal or an ISA signal is detected or not. If an IS signal is detected, it indicates that the base station 101 has not received the packet transmitted last time yet so that the packet transmission control circuit 127 retransmits the packet transmitted last time. If an ISA signal is detected, it indicates that the packet transmitted last time is correctly and reliably received by the base station 101 so that the packet transmission control section 127 transmits the next packet.

Now, the timings of transmission/reception of an IS signal, an ISA signal and a packet of the radio communication system using the ISMA method will be discussed by referring to the timing chart of FIG. 4.

If there is no terminal 102 currently using the communication channel, the base station 101 transmits an IS signal. Assume that the time that elapses between the time when the base station 101 transmits an IS signal and the time when the packet sent from the remotest terminal in response to the IS signal arrives to the base station 101 is delay time a. Once the base station 101 transmits an IS signal, it transmits the next IS signal only after a time equal to or longer than the delay time a. If a terminal 102 has a packet it needs to send, it transmits the packet to the base station 101 immediately after the reception of the IS signal if the probability is not lower than ñ and does not transmit the packet if the probability is not higher than 1−ñ. If the base station 101 receives a packet from a terminal 102 before the delay time a elapses after the last transmission of an IS signal, it transmits an ISA signal after the communication channel becomes idle next time. If two or more than two packets are sent from different terminals 102 and a collision of packets occurs, the base station 101 transmits not an ISA signal but an IS signal when the communication channel becomes idles next time. If such a collision of packets occurs, the terminals which transmitted the packets retransmit the same respective packets.

Now, the procedure that the base station 101 follows when transmitting an IS signal (or an ISA signal) will be discussed by referring to the flow chart of FIG. 5.

The base station 101 constantly monitors the communication channel to see if the component channel is idle or being used and, if the communication channel is idle, it transmits an IS signal to each of the terminals 102 to notify it of the fact that the communication channel is idle (Step S201).

Thereafter, the base station 101 monitors the communication channel for time period a to see if any packet is transmitted to the communication channel (Step S202).

Subsequently, the base station 101 determines if any packet is transmitted or not during the time period a (Step S203). If no packet is transmitted, it repeats the above steps from Step S201 and retransmits an IS signal.

If a packet is transmitted during the time period a, the base station 101 receives that packet (Step S204). Then, the base station 101 determines if the packet is correctly and reliably received or not, typically referring to the error detection code of the packet, and if it is determined that the packet is correctly and reliably received, it returns to Step S201 and transmits an ISA signal after the communication channel becomes idle. If, on the other hand, the packet is not correctly and reliably received because of collision, noise or some other reason, the base station 101 transmits an IS signal in Step S201 when the communication channel becomes idle.

Now, the procedure to be followed by the terminals 102 when transmitting a packet will be discussed by referring to the flow chart of FIG. 6.

The terminal 102 constantly monitors the input interface to see if a request for data transmission arrives by way of the input interface or not and, if there is a request for data transmission, it prepares a packet by assembling the data to be transmitted into the packet (Step S211).

After completing the preparation of the packet for transmission, the terminal 102 waits for the IS signal transmitted from the base station 101 (Step S212).

Upon receiving the IS signal, the terminal 102 computationally determines the probability of transmission of the packet (Step S213). The terminal 102 leaves the packet over without transmitting it if the probability is not higher than 1−ñ and then returns to Step S122, where it waits for the reception of the next IS signal. On the other hand, the terminal 102 actually transmits the packet if the probability is not lower than ñ (Step S214).

Thereafter, the terminal 102 waits for the next IS signal and determines if an ISA signal is transmitted from the base station 101 or not (Step S215). If the terminal 102 receives an ISA signal, it returns to Step S211 and prepares the next packet to be transmitted. If, on the other hand, the terminal 102 receives not an ISA signal but an IS signal, it repeats the steps from Step S212 and retransmits the same packet.

As discussed above, of the radio communication system using the ISMA method, the base station 101 transmits an IS signal to each of the terminals 102 and any of the terminals that receives the IS signal can transmit a packet to the base station 101.

However, while the known radio communication system using the ISMA method is designed to reduce the risk of collision of the packets transmitted from a plurality of terminals by using an IS signal, an ISA signal and the probability of transmission, the possible interference of some other system that uses the same radio frequency is not taken into consideration. In other words, if there is some other system that uses the same frequency band, it can interfere with the operation of the radio communication system.

For example, if a radio frequency band is shared by some other system (e.g., a meteorological radar system) as shown in FIG. 7, there exists radio waves output from said other system regardless of the transmission control of the radio communication system using the ISMA method under consideration. Since the IS signal is transmitted periodically, it can constantly interfere with the operation of said some other system (e.g., a meteorological radar system). Not only the IS signal but also the packets transmitted from any of the terminals of the radio communication system under consideration can interfere with the operation of said other system. Beside interfering with the some other system, the radio communication system using the ISMA method under consideration can also be suffered from errors in the IS signal and the packets that consequently degrade the reliability of radio communications.

For example, if the radio communication system using the ISMA method operates with a radio frequency band between 5.25 GHz and 5.35 GHz, the above identified problems arise because such a radio frequency band is normally used by meteorological radars.

### BRIEF SUMMARY OF THE INVENTION

In view of the above identified circumstances, it is therefore the object of the present invention to provide a radio communication device, a radio communication system comprising a bases station and a plurality of terminal communication devices and a radio communication method that can reduce the risk of interfering with the operation of some other system using a same frequency band and also the risk of degrading its performance due to the interference of some other system using a same frequency band.

According to the invention, the above object is achieved by providing a radio communication device adapted to radio communications using a predetermined frequency band, said device comprising:

an information signal detection means for detecting an information signal transmitted from some other radio communication device;

an idle signal transmission means for transmitting an idle signal, notifying other radio communication devices of the idle state of said predetermined frequency band of non-detection of an information signal transmitted from some other radio communication device as detected by said information signal detection means; and

an interference wave signal detection means for detecting any interference wave signal being transmitted by way of said predetermined frequency band; and

said idle signal transmission means being adapted to avoid transmission of said idle signal upon detection of an interference wave signal.

In another aspect of the invention, there is also provided a radio communication device adapted to radio communications using a predetermined frequency band, said device comprising:

an information signal detection means for detecting an information signal transmitted from some other radio communication device;

an idle signal transmission means for transmitting an idle signal, notifying other radio communication devices of the idle state of said predetermined frequency band of non-detection of an information signal transmitted from some other radio communication device as detected by said information signal detection means;

an interference wave signal detection means for detecting any interference wave signal being transmitted by way of said predetermined frequency band;

an interference wave signal transmission pattern estimation means for estimating the temporal pattern of transmission of the interference wave signal as detected by said interference wave signal detection means; and

said idle signal transmission means being adapted to computationally determine the timing for the idle signal and the information signal transmitted from some other radio communication device in response to said idle signal not overlapping the (time of) transmission of said interference wave signal and transmit said idle signal at the computationally determined timing.

In still another aspect of the invention, there is provided a radio communication device adapted to radio communications using a predetermined frequency band, said device comprising:

an information signal detection means for detecting an information signal transmitted from some other radio communication device;

an idle signal transmission means for transmitting an idle signal, notifying other radio communication devices of the idle state of said predetermined frequency band of non-detection of an information signal transmitted from some other radio communication device as detected by said information signal detection means; and

an interference wave signal detection means for detecting the signal level any interference wave signal being transmitted by way of said predetermined frequency band; and

said idle signal transmission means being adapted to transmit said idle signal by containing therein level information indicating the signal level of said interference wave signal.

In still another aspect of the invention, there is also provided a radio communication device adapted to radio communications using a predetermined frequency band, said device comprising:

an information signal detection means for detecting an information signal transmitted from some other radio communication device;

an idle signal transmission means for transmitting an idle signal, notifying other radio communication devices of the idle state of said predetermined frequency band of non-detection of an information signal transmitted from some other radio communication device as detected by said information signal detection means;

an interference wave signal detection means for detecting any interference wave signal being transmitted by way of said predetermined frequency band; and

an interference wave signal transmission pattern estimation means for estimating the temporal pattern of transmission of the interference wave signal as detected by said interference wave signal detection means; and

said idle signal transmission means being adapted to transmit said idle signal by containing therein time length information indicating the time length available for forwarding the transmission of said information signal from some other radio communication means as transmitted in response to said idle signal without overlapping with the interference wave signal, if any, on the basis of the pattern estimated by said interference wave signal transmission pattern estimation means.

In still another aspect of the invention, there is also provided a radio communication device adapted to radio communications using a predetermined frequency band, said device comprising:

an idle signal reception means for receiving an idle signal transmitted from some other radio communication device and indicating the availability of said predetermined frequency range;

an information signal transmission means for transmitting an information signal to said some other radio communication means having transmitted said idle signal according to the timing of receiving said idle signal;

said idle signal containing level information indicating the signal level of any interference wave signal being transmitted by way of said predetermined frequency range; and

said information signal transmission means being adapted to transmit said information signal to its base station, indicating the detectable signal level as determined on the basis of said signal level of the interference wave signal.

In still another aspect of the invention, there is also provided a radio communication device adapted to radio communications using a predetermined frequency band, said device comprising:

an idle signal reception means for receiving an idle signal transmitted from some other radio communication device and indicating the availability of said predetermined frequency range;

an information signal transmission means for transmitting an information signal to said some other radio communication means having transmitted said idle signal according to the timing of receiving said idle signal;

said idle signal containing time length information indicating the time length available for signal transmission without overlapping with the interference wave signal, if any, being transmitted by way of said predetermined frequency range; and

said information signal transmission means being adapted to transmit an information signal on the time length available for signal transmission directed to its base station as determined on the basis of said time length information.

In still another aspect of the invention, there is provided a radio communication system comprising a base station and one ore more than one terminal communication devices for radio communications between said base station and said one or more than one terminal communication devices, using a predetermined frequency band;

said base station having:

an information signal detection means for detecting an information signal transmitted from said terminal communication device or any of said terminal communication devices;

an idle signal transmission means for transmitting an idle signal, notifying said one or more than one other terminal communication devices of the idle state of said predetermined frequency band of non-detection of an information signal transmitted from said terminal communication device or any of said terminal communication devices as detected by said information signal detection means;

an interference wave signal detection means for detecting any interference wave signal being transmitted by way of said predetermined frequency band;

said idle signal transmission means being adapted to avoid transmission of said idle signal upon detection of an interference wave signal; and

said terminal communication device or each of said terminal communication devices being adapted to transmit an information signal according to the timing of receiving said idle signal transmitted from said base station.

In still another aspect of the invention, there is provided a radio communication system comprising a base station and one ore more than one terminal communication devices for radio communications between said base station and said one or more than one terminal communication devices, using a predetermined frequency band;

said base station having:

an information signal detection means for detecting an information signal transmitted from said terminal communication device or any of said terminal communication devices;

an idle signal transmission means for transmitting an idle signal, notifying said one or more than one other terminal communication devices of the idle state of said predetermined frequency band of non-detection of an information signal transmitted from said terminal communication device or any of said terminal communication devices as detected by said information signal detection means;

an interference wave signal detection means for detecting the level of any interference wave signal being transmitted by way of said predetermined frequency band; and

an interference wave signal transmission pattern estimation means for estimating the temporal pattern of transmission of the interference wave signal as detected by said interference wave signal detection means;

said idle signal transmission means being adapted to computationally determine the timing for the idle signal and the information signal transmitted from said terminal communication device or any of said terminal communication devices in response to said idle signal not overlapping the (time of) transmission of said interference wave signal on the basis of the pattern estimated by said interference wave signal transmission pattern estimation means and transmit said idle signal at the computationally determined timing; and

said terminal communication device or each of said terminal communication devices being adapted to transmit an information signal to said base station according to the timing of receiving said idle signal transmitted from said base station.

In still another aspect of the invention, there is provided a radio communication system comprising a base station and one ore more than one terminal communication devices for radio communications between said base station and said one or more than one terminal communication devices, using a predetermined frequency band;

said base station having:

an information signal detection means for detecting an information signal transmitted from said terminal communication device or any of said terminal communication devices;

an idle signal transmission means for transmitting an idle signal, notifying said one or more than one other terminal communication devices of the idle state of said predetermined frequency band of non-detection of an information signal transmitted from said terminal communication device or any of said terminal communication devices as detected by said information signal detection means; and

an interference wave signal detection means for detecting the level of any interference wave signal being transmitted by way of said predetermined frequency band;

said idle signal transmission means being adapted to transmit said idle signal by containing therein level information indicating the signal level of said detected interference wave signal; and

said terminal communication device or each of said terminal communication devices being adapted to transmit an information signal on the detectable signal level to said base station according to the timing of receiving said idle signal transmitted from said base station and the level information contained in said idle signal.

In still another aspect of the invention, there is provided a radio communication system comprising a base station and one ore more than one terminal communication devices for radio communications between said base station and said one or more than one terminal communication devices, using a predetermined frequency band;

said base station having:

an information signal detection means for detecting an information signal transmitted from said terminal communication device or any of said terminal communication devices;

an idle signal transmission means for transmitting an idle signal, notifying said one or more than one other terminal communication devices of the idle state of said predetermined frequency band of non-detection of an information signal transmitted from said terminal communication device or any of said terminal communication devices as detected by said information signal detection means;

an interference wave signal detection means for detecting the level of any interference wave signal being transmitted by way of said predetermined frequency band; and

an interference wave signal transmission pattern estimation means for estimating the temporal pattern of transmission of the interference wave signal as detected by said interference wave signal detection means;

said idle signal transmission means being adapted to transmit said idle signal by containing therein time length information indicating the time length available for forwarding the transmission of said information signal from said terminal communication device or any of said terminal communication devices as transmitted in response to said idle signal without overlapping with the interference wave signal, if any, on the basis of the pattern estimated by said interference wave signal transmission pattern estimation means; and

said terminal communication device or each of said terminal communication devices being adapted to transmit an information signal on the time length available for signal transmission to the base station according to the timing of receiving said idle signal transmitted from said base station and the time length information contained in said idle signal.

In still another aspect of the invention, there is provided a radio communication method for radio communications between a base station and one or more than one terminal communication devices, using a predetermined frequency band;

said base station detecting any interference wave signal being transmitted by way of said predetermined frequency band;

said base station transmitting an idle signal to said one or more than one other terminal communication devices, notifying the availability of said predetermined frequency band, avoiding said detected interference wave signal, if any; and

said terminal communication device or each of said terminal communication devices transmitting an information signal according to the timing of receiving said idle signal transmitted from said base station.

In still another aspect of the invention, there is provided a radio communication method for radio communications between a base station and one or more than one terminal communication devices, using a predetermined frequency band;

said base station detecting any interference wave signal being transmitted by way of said predetermined frequency band;

said base station estimating the temporal pattern of transmission of the detected interference wave signal, if any, on the basis of said interference wave signal;

said base station computationally determining the timing for the idle signal and the information signal transmitted from said terminal communication device or any of said terminal communication devices in response to said idle signal not overlapping the (time of) transmission of said interference wave signal on the basis of the estimated pattern and transmitting said idle signal at the computationally determined timing; and

said terminal communication device or each of said terminal communication devices transmitting an information signal to said base station according to the timing of receiving said idle signal transmitted from said base station.

In still another aspect of the invention, there is provided a radio communication method for radio communications between a base station and one or more than one terminal communication devices, using a predetermined frequency band;

said base station detecting the level of any interference wave signal being transmitted by way of said predetermined frequency band;

said base station transmitting an idle signal, containing therein level information indicating the signal level of the detected interference wave signal, if any, to said one or more than one terminal communication devices; and

said terminal communication device or each of said terminal communication devices transmitting an information signal on the detectable signal level to said base station according to the timing of receiving said idle signal and the level information contained in said idle signal.

In still another aspect of the invention, there is provided a radio communication method for radio communications between a base station and one or more than one terminal communication devices, using a predetermined frequency band;

said base station detecting any interference wave signal being transmitted by way of said predetermined frequency band;

said base station estimating the temporal pattern of transmission of the interference wave signal, if any, as detected by said interference wave signal detection means;

said base station transmitting an idle signal, containing the time length information indicating the available time length of said predetermined frequency band for forwarding the transmission of an information signal from said terminal communication device or any of said terminal communication devices without overlapping with the interference wave signal, if any, on the basis of the estimated pattern to said terminal communication device; and

said terminal communication device or each of said terminal communication devices transmitting an information signal on the time length available for signal transmission to the base station according to the timing of receiving said idle signal and the time length information contained in said idle signal.

In still another aspect of the invention, there is provided a radio communication device adapted to radio communications using a plurality of frequency channels, said device comprising:

an information signal detection means for detecting an information signal transmitted from some other radio communication device;

an idle signal transmission means for transmitting an idle signal by using one of said plurality of frequency channels for notifying said some other radio communication device of the availability of said frequency channel;

an interference wave signal detection means for detecting any interference wave signal being transmitted by way of any of said frequency channels; and

said idle signal transmission means being adapted to transmit said idle signal, using a frequency channel free from the detected interference wave signals, if any.

In still another aspect of the invention, there is provided a radio communication device adapted to radio communications using a plurality of frequency channels, said device comprising:

an idle signal reception means for receiving an idle signal transmitted from some other radio communication device by using one of said plurality of frequency channels to notify the availability of said frequency channel;

an information signal transmission means for transmitting an information signal to said some other radio communication device, or the origin of said idle signal, according to the timing of receiving said idle signal; and

said information signal transmission means being adapted to transmit said information signal, using the frequency channel used for the transmission of said idle signal out of said plurality of frequency channels.

In still another aspect of the invention, there is provided a radio communication system comprising a base station and one ore more than one terminal communication devices for radio communications between said base station and said one or more than one terminal communication devices, using a plurality of frequency channels;

said base station having:

an information signal detection means for detecting an information signal transmitted from said terminal communication device or any of said terminal communication devices;

an idle signal transmission means for transmitting an idle signal to said terminal communication device, using any of said plurality of frequency channels, to notify said terminal communication device of the availability of said frequency channel;

an interference wave signal detection means for detecting any interference wave signal being transmitted by way of any of said frequency channels; and

said idle signal transmission means being adapted to transmit said idle signal, using a frequency channel free from the detected interference wave signals, if any,

said terminal communication device or devices having:

an idle signal reception means for receiving said idle signal;

an information signal transmission means for transmitting an information signal to said base station, or the origin of said idle signal, according to the timing of receiving said idle signal; and

said information signal transmission means being adapted to transmit said information signal, using the frequency channel used for the transmission of said idle signal out of said plurality of frequency channels to said base station.

In a further aspect of the invention, there is provided a radio communication method for radio communications between a base station and one or more than one terminal communication devices, using a plurality of frequency channels;

said base station detecting any interference wave signal being transmitted by way of any of said frequency channels;

said base station transmitting an idle signal, using a frequency channel free from the detected interference wave signals, if any, to notify said terminal communication device or devices of the availability of said frequency channel; and

said terminal communication device or devices being adapted to transmit said information signal, using the frequency channel used for the transmission of said idle signal out of said plurality of frequency channels.

Thus, with a radio communication device, a radio communication system and a radio communication method according to the invention can reduce the risk of interfering with the operation of some other system using a same frequency band and also the risk of degrading its performance due to the interference of some other system using a same frequency band.

### BRIEF DESCRIPTION OF THE SEVERAL VIEW OF THE DRAWING

FIG. 1 is a schematic illustration of a known radio communication system;

FIG. 2 is a schematic block diagram of the base station of the known radio communication system of FIG. 1;

FIG. 3 is a schematic block diagram of the terminals of the known radio communication system of FIG. 1;

FIG. 4 is a timing chart of signals exchanged between the base station and the terminals of the known radio communication system of FIG. 1;

FIG. 5 is a flow chart of the operation of the base station of the known radio communication system of FIG. 1;

FIG. 6 is a flow chart of the operation of the terminals of the known radio communication system of FIG. 1;

FIG. 7 is a timing chart of signals exchanged between the base station and the terminals of the known radio communication system of FIG. 1, illustrating the influence of an interference wave from some other system that is found in the communication channel being used by the known radio communication;

FIG. 8 is a schematic illustration of a radio communication system according to the invention;

FIG. 9 is a schematic block diagram of the base station of the first embodiment of radio communication system;

FIG. 10 is a timing chart of signals exchanged between the base station and the terminals of the first embodiment of radio communication system;

FIG. 11 is a flow chart of the operation of the base station of the first embodiment of radio communication system;

FIG. 12 is a schematic block diagram of the base station of the second embodiment of radio communication system;

FIG. 13 is a timing chart of signals exchanged between the base station and the terminals of the second embodiment of radio communication system;

FIG. 14 is a flow chart of the operation of the base station of the second embodiment of radio communication system;

FIG. 15 is a schematic block diagram of the base station of the third embodiment of radio communication system;

FIG. 16 is a schematic block diagram of the terminals of the third embodiment of radio communication system;

FIG. 17 is a flow chart of the operation of the base station of the third embodiment of radio communication system;

FIG. 18 is a flow chart of the operation of the terminals of the third embodiment of radio communication system;

FIG. 19 is a schematic block diagram of the base station of the fourth embodiment of radio communication system;

FIG. 20 is a flow chart of the operation of the base station of the fourth embodiment of radio communication system;

FIG. 21 is a flow chart of the operation of the terminals of the fourth embodiment of radio communication system;

FIG. 22 is a schematic illustration of the frequency band between 5.25 GHz and 5.35 GHz as divided into four frequency channels of 20 MHz.

FIG. 23 is a schematic block diagram of the base station of the fifth embodiment of radio communication system;

FIG. 24 is a schematic block diagram of the terminals of the fifth embodiment of radio communication system;

FIG. 25 is a timing chart of signals exchanged between the base station and the terminals of the fifth embodiment of radio communication system;

FIG. 26 is a flow chart of the operation of the base station of the fifth embodiment of radio communication system;

FIG. 27 is a flow chart of the operation of the terminals of the fifth embodiment of radio communication system;

FIG. 28 is a schematic block diagram of the base station of the sixth embodiment of radio communication system;

FIG. 29 is a schematic block diagram of the terminals of the sixth embodiment of radio communication system;

FIG. 30 is a timing chart of signals exchanged between the base station and the terminals of the sixth embodiment of radio communication system;

FIG. 31 is a flow chart of the operation of the base station of the sixth embodiment of radio communication system; and

FIG. 32 is a flow chart of the operation of the terminals of the sixth embodiment of radio communication system.

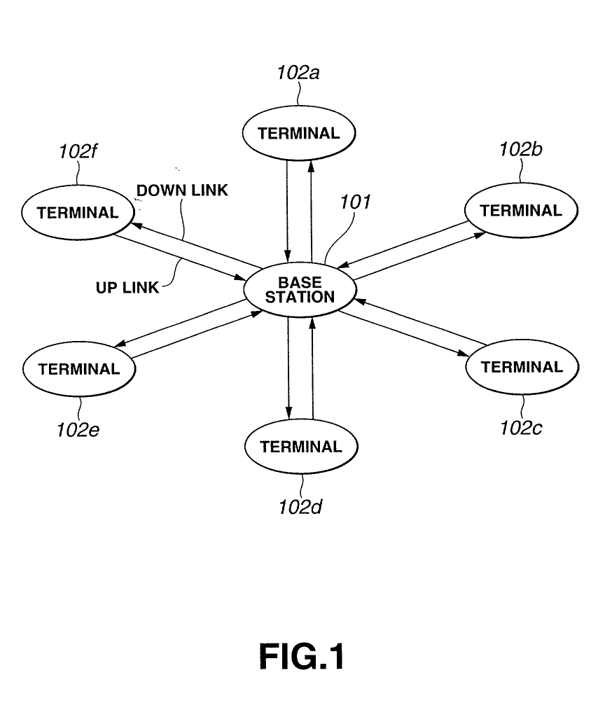

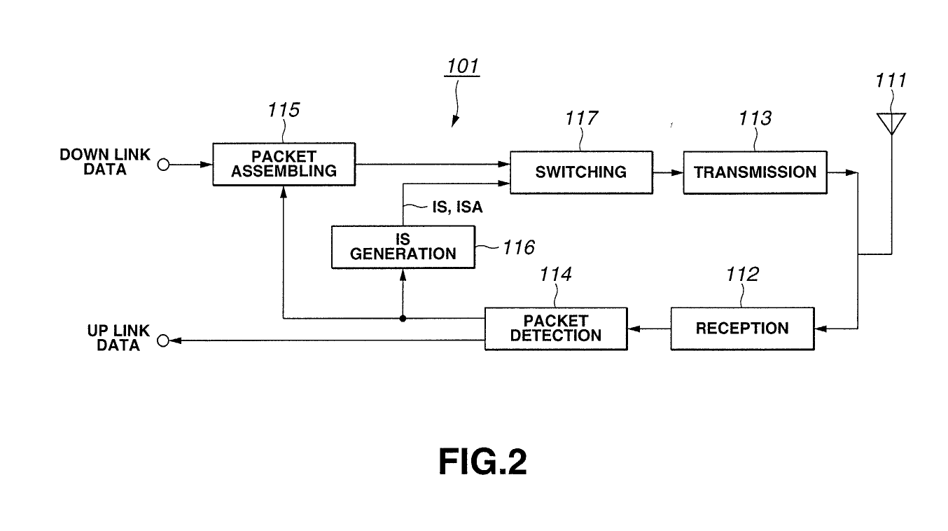

### DETAILED DESCRIPTION OF THE INVENTION

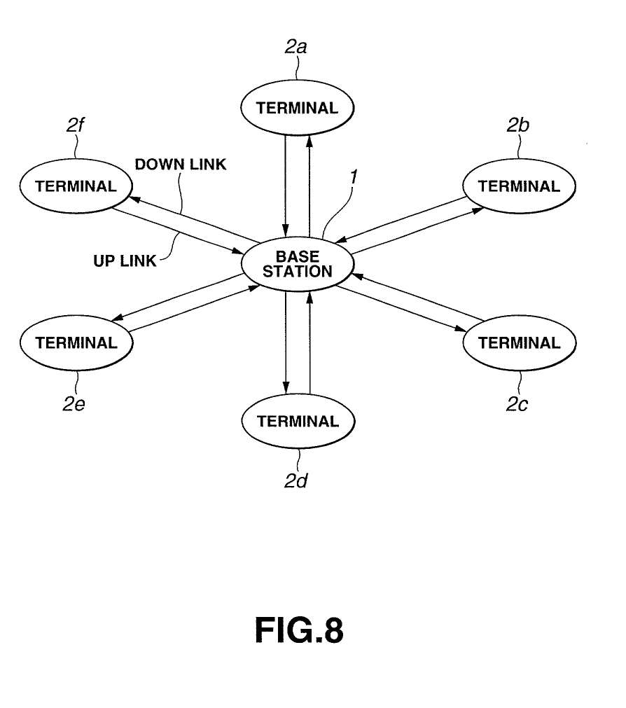

Now, the present invention will be described in greater detail by referring to the accompanying drawings that illustrate the first through sixth embodiment of radio communication system according to the invention. The ISMA method is used in each of the embodiments of radio communication system according to the invention with a radio frequency band that is typically found between 5.25 GHz and 5.35 GHz. As shown in FIG. 8, each of the embodiments comprises a base station 1 and a plurality of terminals 2 (2a through 2f) and a same radio frequency band (communication channel) is shared by the base station 1 and the terminals 2 for radio communications.

[1st Embodiment]

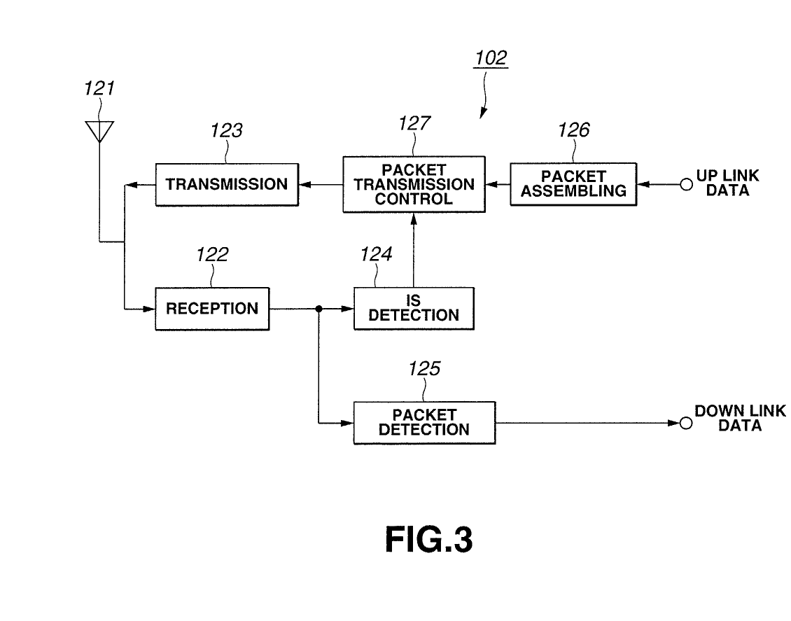

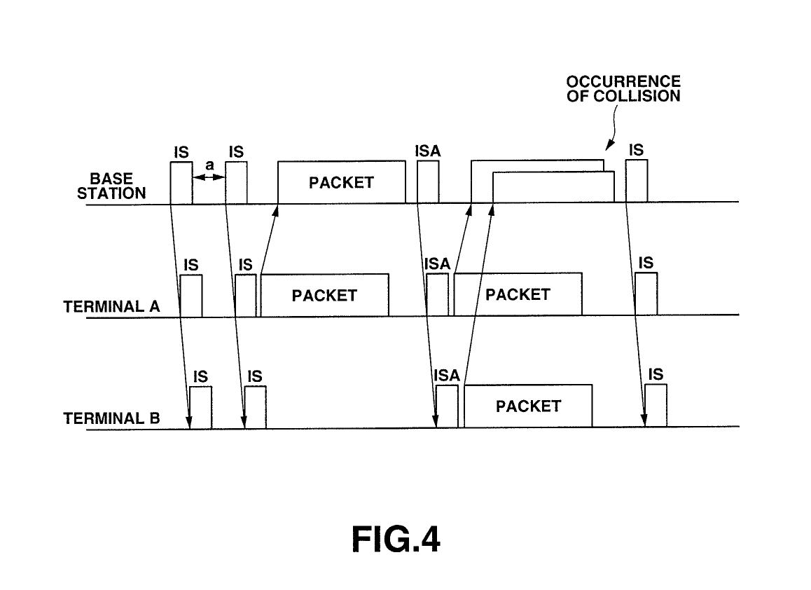

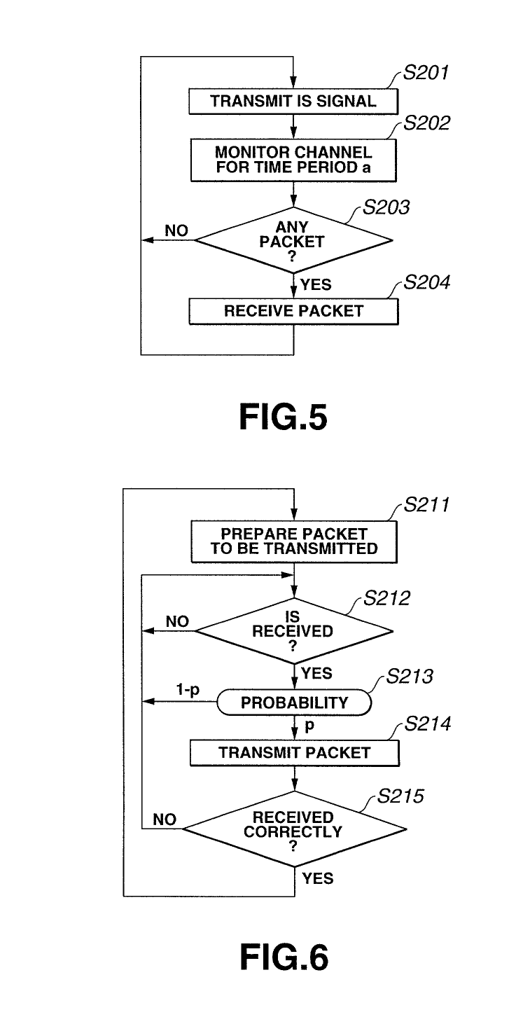

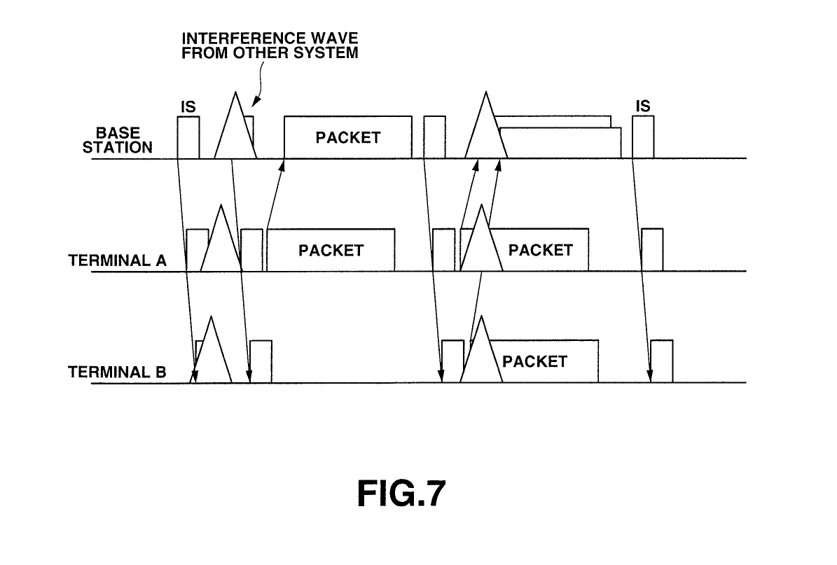

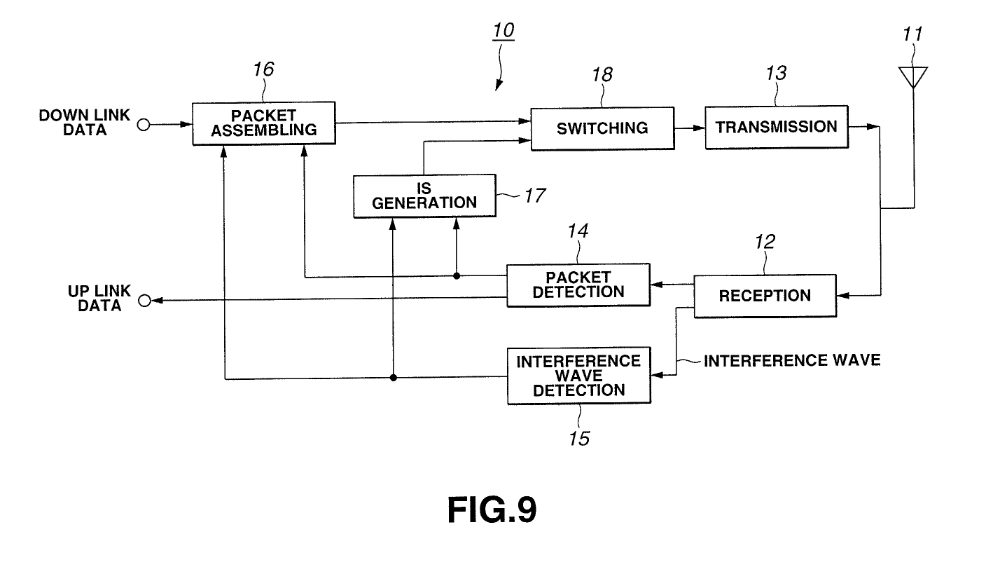

FIG. 9 is a schematic block diagram of the base station of the first embodiment of radio communication system. Note that the terminals of the first embodiment have a configuration same as their counterparts of the known radio communication system as illustrated in FIG. 3 and operate also same as those of the known system.

Referring to FIG. 9, the base station 10 comprises an antenna 11, a reception circuit 12, a transmission circuit 13, a packet detection circuit 14, an interference wave detection circuit 15, a packet assembling circuit 16, an IS generating circuit 17 and a switching circuit 18.

The antenna 11 is adapted to detect the radio wave of the communication channel to be used in the system for signal transmission/reception and also to transmit signals.

The reception circuit 12 is adapted to operations such as frequency conversion and demodulation to be conducted on the RF signal detected by the antenna 11. The reception circuit 12 also receives the interference wave signal, if any, from some other system using the same frequency band. For instance, the reception circuit 12 may receive a radar wave from a meteorological radar system that is found between 5.25 GHz and 5.35 GHz.

The transmission circuit 13 is adapted to operations such as modulation of the data to be transmitted to the terminals, frequency conversion and transmission of an RF signal by way of the antenna 11.

The packet detection circuit 14 is fed with the data received by the reception circuit 12 and determines by referring to the data if there is a terminal 102 or more than one terminals transmitting a packet, using the communication channel assigned to the system. If it is determined that there is a single terminal transmitting a packet, using the communication channel assigned to the system (and hence there are no plurality of terminals transmitting data simultaneously), the packet detection circuit 14 outputs the detected packet to the outside by way of an output interface as up link data.

The interference wave detection circuit 15 carrier senses the communication channel used by the system for a predetermined period of time to find out if the signal received by the reception circuit 12 contains any interference wave signal or not. It may typically finds out if an interference wave signal such as a radar wave of a meteorological radar system that is found between 5.25 GHz and 5.35 GHz is received or not. Then, when a signal is detected, the interference wave detection circuit 15 determines if the detected signal is found above a predetermined threshold or not. Then, the interference wave signal detection circuit 15 determines that there is an interference wave signal if the signal level of the detected signal is above the predetermined threshold, whereas it determines that there is not any interference wave signal if the signal level of the detected signal is below the predetermined threshold.

The packet assembling circuit 16 assembles the down link data input from the outside by way of an input interface into a packet. Then, the packet assembling circuit 16 outputs the packet when it is determined by the packet detection circuit 14 that no other packet is being transmitted by any of the terminals, using the communication channel assigned to the system (and hence the communication channel is in an idle state), and no interference wave signal is detected by the interference wave signal detection circuit 15.

The IS generating circuit 17 generates an IS signal and ISA signal. An IS signal is used to indicate that the communication channel is idle and any of the terminals can use it to transmit a packet to the base station 10 by way of the communication channel. The IS generating circuit 17 outputs an IS signal at a timing when it is determined by the packet detection circuit 14 that the communication channel is not being used and no terminal is transmitting a packet and no down link is taking place and also that no interference wave signal is detected by the interference wave detection circuit 15. An IS signal, an ISA signal and the timing of transmitting/receiving a packet will be discussed in greater detail hereinafter.

The switching circuit 18 is adapted to forward the packet fed from the packet assembling circuit 16 for down link and the IS signal or the ISA signal fed from the IS generating circuit 17 by way of its switching operations matched to their transmission timings.

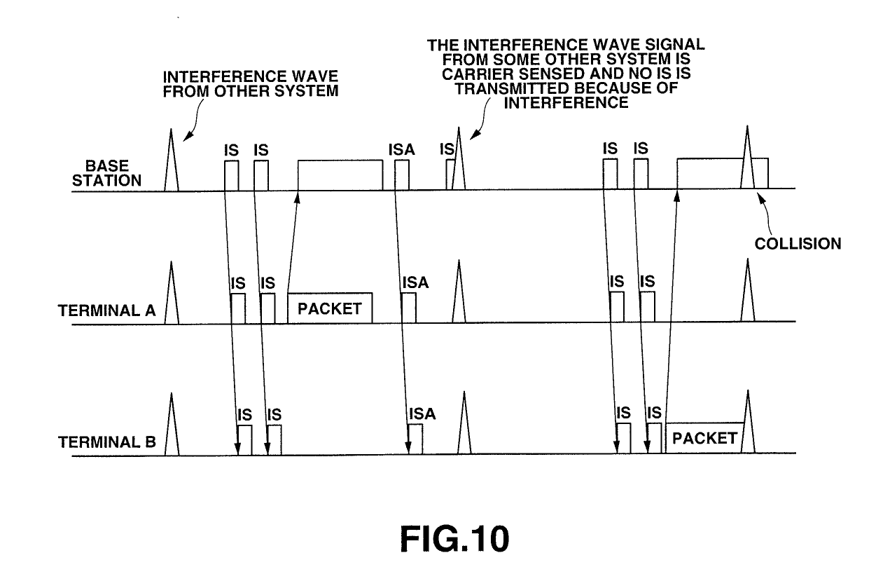

Now, the timings of transmission/reception of an IS signal, an ISA signal and a packet of the first embodiment of radio communication system will be discussed by referring to the timing chart of FIG. 10.

Firstly, assume that an interference wave signal from a meteorological radar system is received by the embodiment and the interference wave signal has a periodical pulse-shaped waveform as shown in FIG. 10.

Before transmitting an IS signal, the base station 10 performs an carrier sensing operation on the communication channel being used by the system to see if an interference wave signal from some other system exists in the communication channel or not. If a signal with a signal level higher than the predetermined threshold is observed as a result of the carrier sensing operation, it is determined by the base station 10 that there is an interference wave signal from some other system and the base station 10 does not transmit any IS signal but performs a carrier sensing operation once again. If, on the other hand, no signal with a signal level higher than the predetermined threshold is observed as a result of the carrier sensing, it is determined by the base station 10 that there is no interference wave signal from some other system.

If there is no interference wave signal nor is there any terminal using the communication channel, the base station 10 transmits an IS signal.

After transmitting an IS signal, the base station 10 monitors the communication channel for delay time a (the time that elapses between the time when the base station 10 transmits an IS signal and the time when the packet sent from the remotest terminal in response to the IS signal arrives to the base station) and determines if a packet is sent from a terminal or not. If it is found that no packet is sent from a terminal during of the delay time a, the base station 10 performs another carrier sensing operation and, if no interference wave signal is found as a result of the carrier sensing operation, it transmits an IS to each of the terminals. If, on the other hand, it is found that a packet is sent from a terminal during the delay time a, the base station 10 receives the packet and then determines if the packet is correctly and reliably received or not, typically referring to the error detection code of the packet. If it is determined that the packet is not correctly and reliably received, the base station 10 performs another carrier sensing operation and subsequently transmits an IS signal to each of the terminals. If, on the other hand, it is determined that the packet is correctly and reliably received, the base station 10 performs another carrier sensing operation and transmits an ISA signal to each of the terminals.

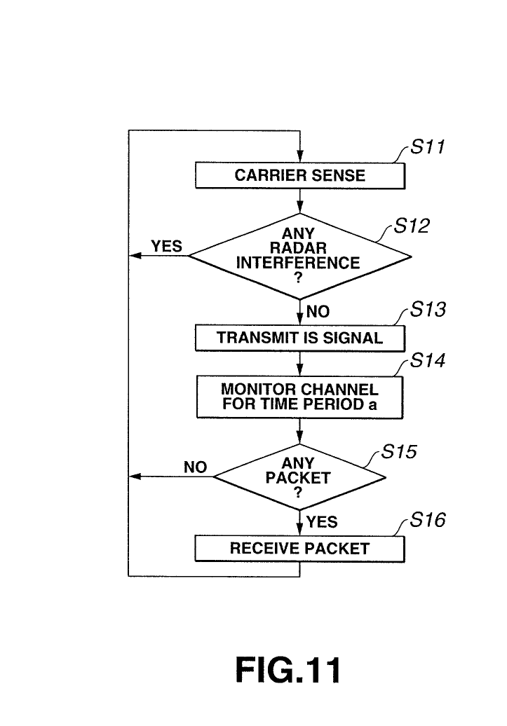

Now, the procedure that the base station 10 follows when transmitting an IS signal (or an ISA signal) will be discussed by referring to the flow chart of FIG. 11.

Firstly, the base station 10 performs a carrier sensing operation (Step S11).

Then, the base station 10 determines if there is an interference wave signal such as a radar wave or not on the basis of the result obtained by the carrier sensing operation (Step S12). If it is determined that there is an interference wave signal, the processing operation returns to Step Sll, where the base station 10 performs another carrier sensing operation.

If, on the other hand, it is determined that there is not any interference wave signal, the base station 10 subsequently transmits an IS signal (Step S13).

Then, the base station 10 monitors the communication channel for time period a to see if any packet is transmitted to the communication channel (Step S14).

Subsequently, the base station 10 determines if any packet is transmitted or not during the time period a (Step S15). If no packet is transmitted, it repeats the above steps from Step S11, performs another carrier sensing operation and retransmits an IS signal.

If a packet is transmitted during the time period a, the base station 10 receives that packet (Step S16). Then, the base station 10 determines if the packet is correctly and reliably received or not, typically referring to the error detection code of the packet, and if it is determined that the packet is correctly and reliably received, it returns to Step S11 and transmits an ISA signal after performing another carrier sensing operation. If, on the other hand, the packet is not correctly and reliably received because of collision, noise or some other reason, the base station 10 transmits an IS signal in Step S10.

As discussed above, of the first embodiment of radio communication system having the above described configuration, the base station 10 performs a carrier sensing operation to see if there exists an interference wave signal from some other system in the communication channel or not before transmitting an IS signal. Therefore, with this first embodiment of radio communication system, it is possible for the base station 10 to transmit an IS signal without the risk of interference with any other system. Therefore, if there exists some other system using the same communication channel, the risk of interfering with the operation of the other system using the same frequency band and also the risk of degrading the performance the embodiment due to the interference of the other system using the same frequency band can be minimized.

Additionally, with the first embodiment of radio communication system, each of the terminals transmits a packet only after receiving an IS signal. In other words, no IS signal is transmitted from the base station and hence no packet is transmitted from any of the terminals when there is an interference wave signal from some other system. Then, the risk of degrading the performance the embodiment due to the interference of a packet transmitted from any of the terminals and the other system using the same frequency band can be minimized if the terminals have a configuration same as comparable conventional terminals.

[2nd Embodiment]

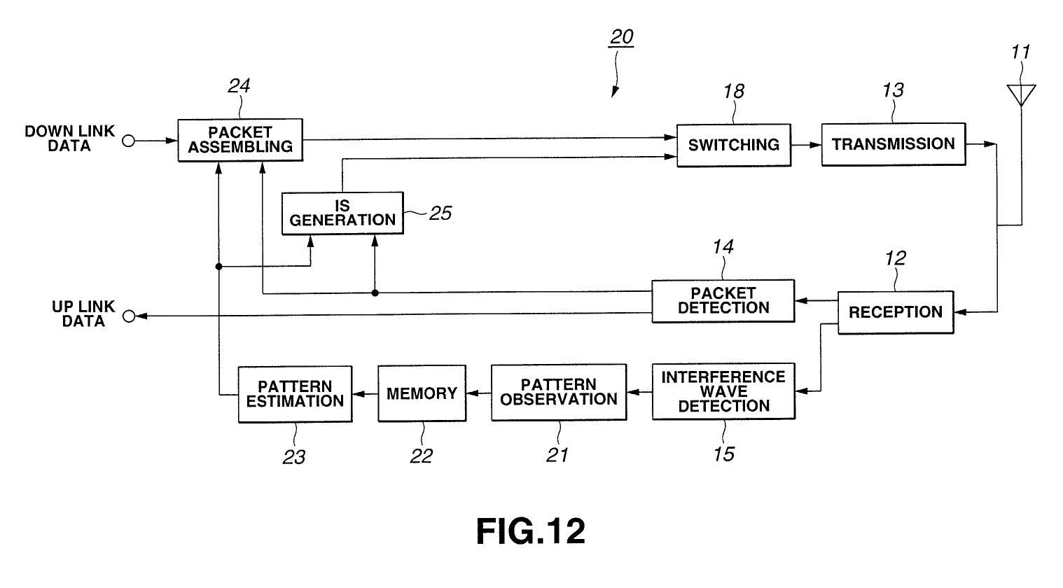

FIG. 12 is a schematic block diagram of the base station of the second embodiment of radio communication system. Note that the terminals of the second embodiment have a configuration same as their counterparts of the known radio communication system as illustrated in FIG. 3 and operate also same as those of the known system. In FIG. 12, the components of the base station 10 that are same as those of the first embodiment are denoted respectively by the same reference symbols and will not be described any further.

Referring to FIG. 12, the base station 10 comprises an antenna 11, a reception circuit 12, a transmission circuit 13, a packet detection circuit 14, an interference wave detection circuit 15, switching circuit 18, a pattern observation circuit 21, a memory 22, a pattern estimation circuit 23, a packet assembling circuit 24 and an IS generating circuit 25.

The pattern observation circuit 21 acquires information on the interference wave signal, if any, obtained by a carrier sensing operation of the interference wave detection circuit 15 and observes the acquired information for a predetermined period of time to find out the temporal pattern produced by the interference wave signal. For instance, if the interference wave signal is coming from a meteorological radar system, it will be a periodical signal generated at regular intervals so that the pattern observation circuit 21 finds out the cycle of generation of the interference wave signal.

The memory 22 stores the temporal pattern produced by the interference wave signal observed by the pattern observation circuit 21.

The pattern estimation circuit 23 estimates the timing of the next generation of the interference wave signal on the basis of the temporal pattern stored in the memory 22 the current time.

The packet assembling circuit 24 assembles the down link data input from the outside by way of an input interface into a packet. Then, the packet assembling circuit 24 outputs the packet when it is determined by the packet detection circuit 14 that no other packet is being transmitted by any of the terminals, using the communication channel assigned to the system (and hence the communication channel is in an idle state). Furthermore, the packet assembling circuit 24 outputs the packet when it is determined that no interference wave signal is generated during the transmission of the packet on the basis of the estimated information of the pattern estimation circuit 23.

The IS generating circuit 25 generates an IS signal and ISA signal. The IS generating circuit 25 outputs an IS signal at a timing when it is determined by the packet detection circuit 14 that no terminal is transmitting a packet, using the communication channel and no down link is taking place and when it is determined on the basis of the information from the pattern estimation circuit 23 that, if an IS signal is transmitted now, no interference wave signal will be produced while the packet is transmitted in response to the IS signal.

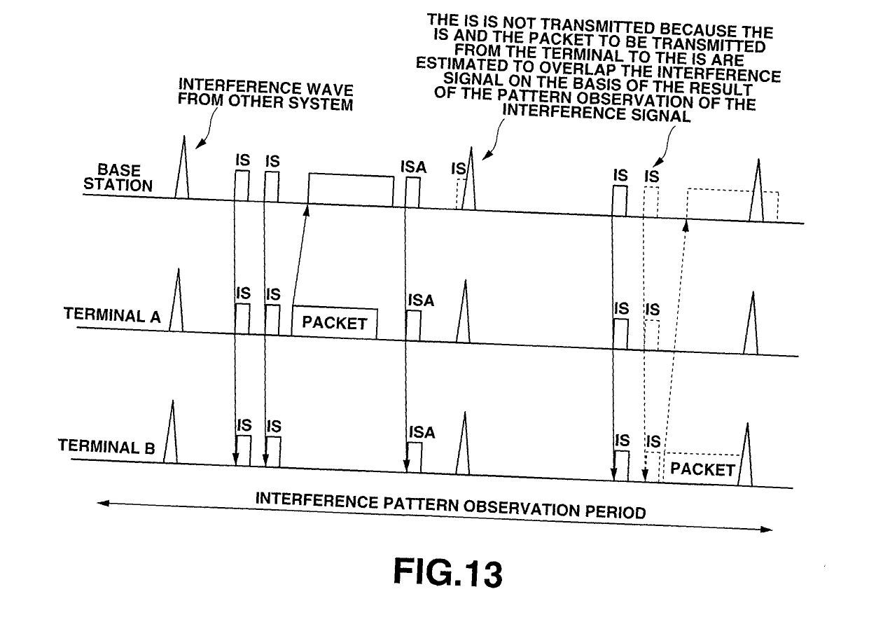

Now, the timings of transmission/reception of an IS signal, an ISA signal and a packet of the second embodiment of radio communication system will be discussed by referring to the timing chart of FIG. 13.

The base station 20 performs a carrier sensing operation for a predetermined period of time at regular intervals and observes the temporal pattern indicating the timing of occurrence of an interference wave signal. The information on the observed temporal pattern indicating the timing of occurrence of an interference wave signal is then stored in the memory 22.

When transmitting an IS signal, firstly, the base station 20 estimates by referring to the temporal pattern stored in the memory 22 and on the assumption that an IS signal is transmitted now if an interference wave signal is produced between now and the time when a packet transmitted in response to the IS signal arrives it. If it is estimated that a collision of the IS signal and/or the packet from the terminal and the interference wave signal will highly probably occur, the base station 20 suspends the transmission of an IS signal. However, if it is estimated that such a collision will not probably occur, it transmits an ordinary IS signal. Since the temporal pattern of occurrence of an interference wave signal can change with time, the base station 20 performs a carrier sensing operation for a predetermined period of time at regular intervals to update the stored temporal pattern.

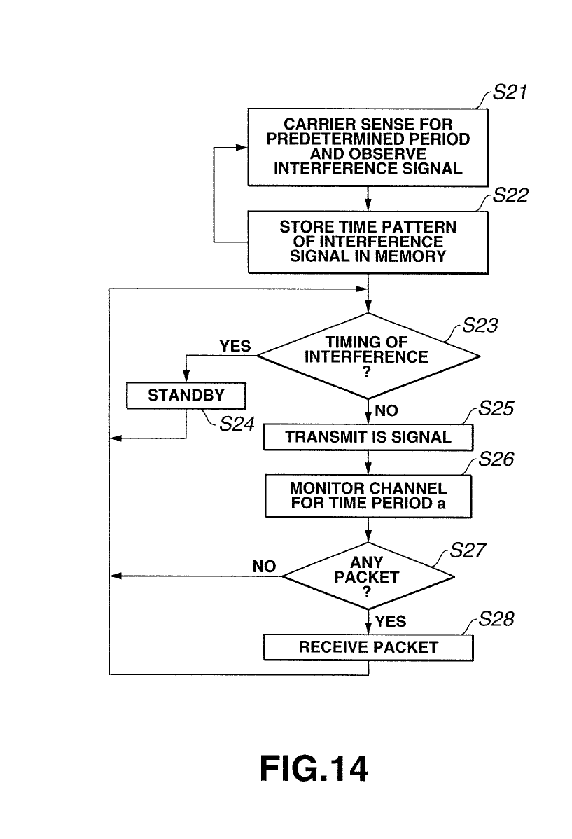

Now, the procedure that the base station 20 follows when transmitting an IS signal (or an ISA signal) will be discussed by referring to the flow chart of FIG. 14.

Firstly, the base station 20 performs a carrier sensing operation for a predetermined period of time at regular intervals to observe the temporal pattern of occurrence of the detected interference wave signal, if such a signal is ever detected (Step S21). The information on the observed temporal pattern of occurrence of an interference wave signal is stored in the memory 22 (Step S22).

Then, on the assumption that an IS signal is transmitted now, the base station estimates if an interference wave signal is produced between now and the time when a packet transmitted in response to the IS signal arrives it (Step S23). If it is estimated that an interference wave signal will be produced, the base station 20 stays in a standby state until an interference wave signal is produced (Step S24) and then returns to Step S23, where it carries out the estimation once again.

If, on the other hand, it is estimated that an interference wave signal will not be produced, the base station 20 transmits an IS signal (Step S25).

Then, the base station 20 monitors the communication channel for time period a to see if any packet is transmitted to the communication channel (Step S26).

Subsequently, the base station 20 determines if any packet is transmitted or not during the time period a (Step S27). If no packet is transmitted, it repeats the above steps from Step S23, performs the estimation for another time and retransmits an IS signal.

If a packet is transmitted during the time period a, the base station 20 receives that packet (Step S28). Then, the base station 20 determines if the packet is correctly and reliably received or not, typically referring to the error detection code of the packet, and if it is determined that the packet is correctly and reliably received, it returns to Step S23 and transmits an ISA signal after performing the estimation for still another time. If, on the other hand, the packet is not correctly and reliably received because of collision, noise or some other reason, the base station 20 transmits an IS signal in Step S25.

As discussed above, of the second embodiment of radio communication system having the above described configuration, the base station 20 performs a carrier sensing operation to generates a temporal pattern indicating the timing at which an interference wave signal, if any, is produced. Then, it estimates the timing at which the next interference wave signal is produced on the basis of the temporal pattern. If it is estimated that, on an assumption that an IS signal is transmitted, the IS signal and/or the packet transmitted in response to the IS signal and the interference wave will highly probably collide with each other, the base station 20 avoids the transmission of the IS signal. Therefore, of the second embodiment of radio communication system, the base station 20 can transmit an IS signal without interfering with some other system.

Additionally, of the second embodiment of radio communication system, the base station 20 estimates the timing at which an interference wave signal occurs to avoid, if necessary, the transmission of an IS signal so that the packet transmitted from any of the terminals of the system will not interfere with the operation of some other system and hence the reliability of the communicating operation of the system can be improved if the terminals have a configuration same as comparable conventional terminals.

While the base station 20 of the second embodiment performs a carrier sensing operation for a predetermined period of time at regular intervals in the above description, it is not necessary for the carrier sensing operation to be conducted at regular intervals.

For instance, it may be so arranged that the base station 20 performs the carrier sensing operation only once before the system starts operating. Then, the system configuration may be simplified because the carrier sensing operation is conducted only once.

Alternatively, it may be so arranged that the base station 20 performs the carrier sensing operation on an irregular basis only when the system is idle and not operating for communication. Then, the estimated temporal pattern of occurrence of the detected interference wave signal can be updated to reduce the estimation error. Additionally, since the operation of the system does not need to be forcibly stopped, the efficiency of communicating operation of the system can be improved.

Still alternatively it may be so arranged that the base station 20 performs the carrier sensing operation on the basis of a combination of regular intervals and the use of idle time. Then, the estimation of the timing of production of an interference wave signal can become more reliable.

While the information on the temporal pattern of occurrence of an interference wave signal is stored in the memory of the base station 20 in the above description of the second embodiment of radio communication system, it may alternatively be so arranged that the temporal pattern of occurrence of an interference wave signal is estimated by means of a counter that is synchronized with the occurrence of the interference wave signal.

Furthermore, the second embodiment may be appropriately combined with the first embodiment. Then, the presence of an interference wave signal in the communication carrier is detected by a carrier sensing operation before transmitting an IS signal and the temporal pattern of occurrence an interference wave signal is estimated and the transmission of an IS signal is avoided whenever the IS signal and/or the packet transmitted in response to the IS signal can collide with the interference wave signal.

[3rd Embodiment]

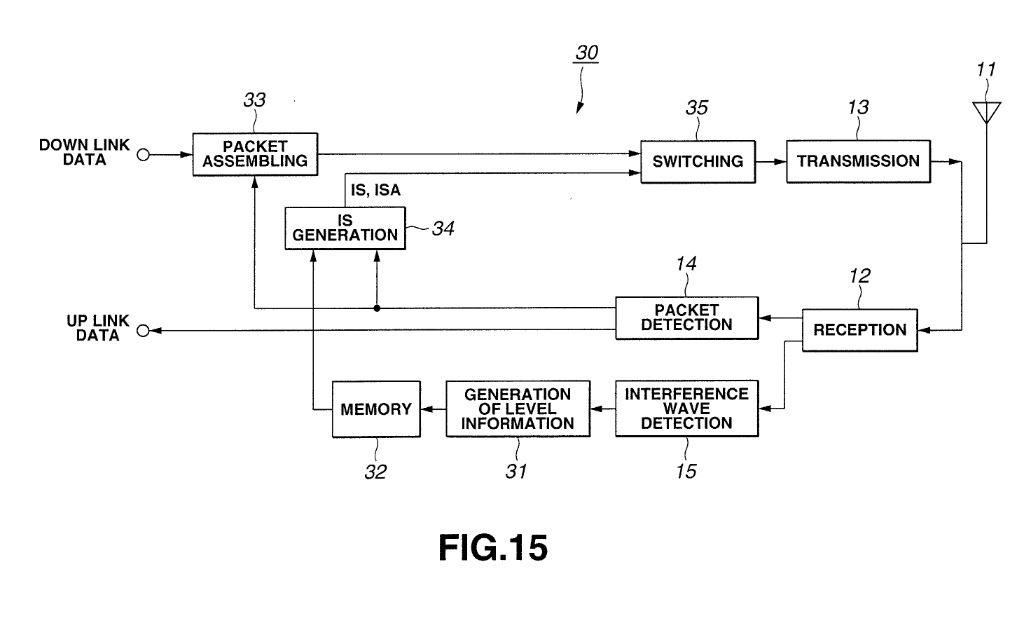

FIG. 15 is a schematic block diagram of the base station of the third embodiment of radio communication system.

In FIG. 15, the components of the base station of the third embodiment that are same as those of the first embodiment are denoted respectively by the same reference symbols and will not be described any further.

Referring to FIG. 15, the base station 30 comprises an antenna 11, a reception circuit 12, a transmission circuit 13, a packet detection circuit 14, an interference wave detection circuit 15, a packet assembling circuit 33, a switching circuit 35, a level information generating circuit 31, a memory 32 and an IS generating circuit 34.

The level information generating circuit 31 generates interference wave signal level information on the signal level of the interference wave signal detected and observed for a predetermined period of time by the interference wave detection circuit 12. This information may typically contain the average of the peak values of the signal level, the value of the integral of the interference wave signal for the predetermined period of time and/or the information on the reception level of the interference wave signal existing in the communication carrier and received by the base station 30.

The memory 32 stores the interference wave signal level information generated by the level information generating circuit 31.

The IS generating circuit 34 generates an IS signal and an ISA signal. The IS generating circuit 34 outputs an IS signal at a timing when it is determined by the packet detection circuit 14 that no terminal is transmitting a packet, using the communication channel and no down link is taking place.

The IS generating circuit 34 generates and outputs an IS signal and an ISA signal containing the interference wave signal level information stored in the memory 32.

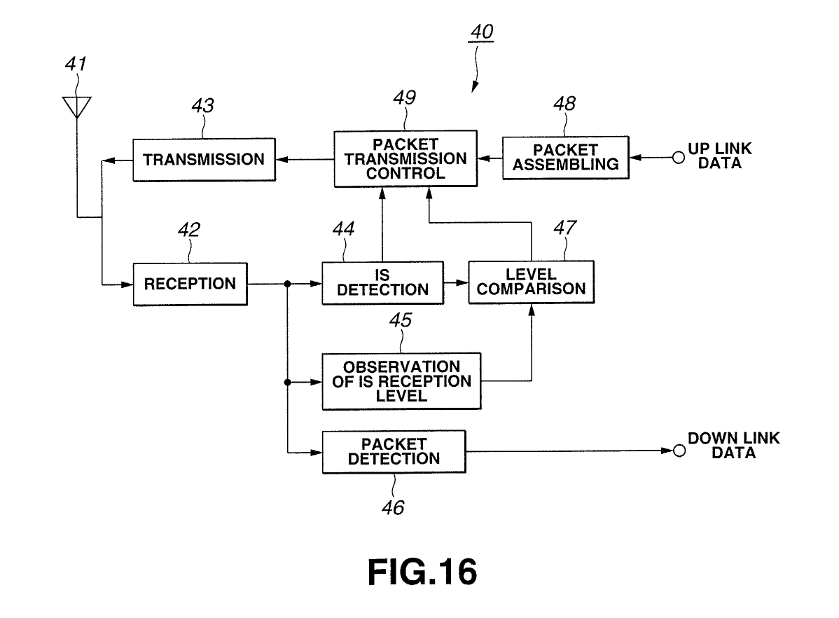

Now, the configuration of the terminals of the third embodiment of radio communication system will be described by referring to FIG. 16.

The terminal 40 comprises an antenna 41, a reception circuit 42, a transmission circuit 43, an IS detection circuit 44, an IS reception level observation circuit 45, a packet detection circuit 46, a level comparison circuit 47, a packet assembling circuit 48 and a packet transmission control circuit 49.

The antenna 41 is adapted to detect the radio wave of the communication channel to be used in the system for signal transmission/reception and also to transmit signals.

The reception circuit 42 is adapted to operations such as frequency conversion and demodulation to be conducted on the RF signal detected by the antenna 41.

The transmission circuit 43 is adapted to operations such as modulation of the data to be transmitted to the base station 30, frequency conversion and transmission of an RF signal by way of the antenna 41.

The IS detection circuit 44 detects the IS signal or the ISA signal transmitted from the base station 30. Additionally, the IS detection circuit 44 extracts the interference wave signal level information contained in the IS signal and the ISA signal and supplies it to the level comparison circuit 47.

The IS reception level observation circuit 45 observes the reception level of the IS signal and the ISA signal transmitted from the base station 30. Then, the IS reception level observation circuit 45 supplies the observed signal level of the IS signal to the level comparison circuit 47.

The packet detection circuit 46 identifies the packet transmitted from the base station 30 and, if the received packet is sent from the base station 30 to the terminal 40 itself, outputs it to the outside by way of an output interface as down link data.

The level comparison circuit 47 compares the signal level of the IS signal and the ISA signal observed by the IS reception level observation circuit 45 and the signal level of the interference wave signal as indicated by the interference wave signal level information contained in the IS signal and the ISA signal.

The packet assembling circuit 48 assembles the up link data input to it from the outside by way of an input interface into a packet.

The packet transmission control circuit 49 carries out operations such as scheduling the timing of transmitting the packet fed from the packet assembling circuit 48 and acknowledging the transmission of the packet. More specifically, when the IS detection circuit 44 detects an IS signal, the packet transmission control circuit 49 determines if the communication channel is available or not and, if it is determined that the communication channel is available, it transmits the packet immediately after the reception of the IS signal. At this time, the packet transmission control circuit 49 transmits the packet when it determines that the reception level of the IS signal is sufficiently higher than the signal level of the interference wave signal according to the result of comparison of the level comparison circuit 47. Additionally, the packet transmission control circuit 49 determines the probability of transmission of the packet and actually transmits the packet if the probability is not lower than ñ, but it does not if the probability is not higher than 1−ñ.

Additionally, after the transmission of the packet, the packet transmission control circuit 49 determines if an IS or an ISA signal is detected or not. If an IS signal is detected, it indicates that the base station 30 has not received the packet transmitted last time yet so that the packet transmission control circuit 49 retransmits the packet transmitted last time. If an ISA signal is detected, it indicates that the packet transmitted last time is correctly and reliably received by the base station 30 so that the packet transmission control section 49 transmits the next packet.

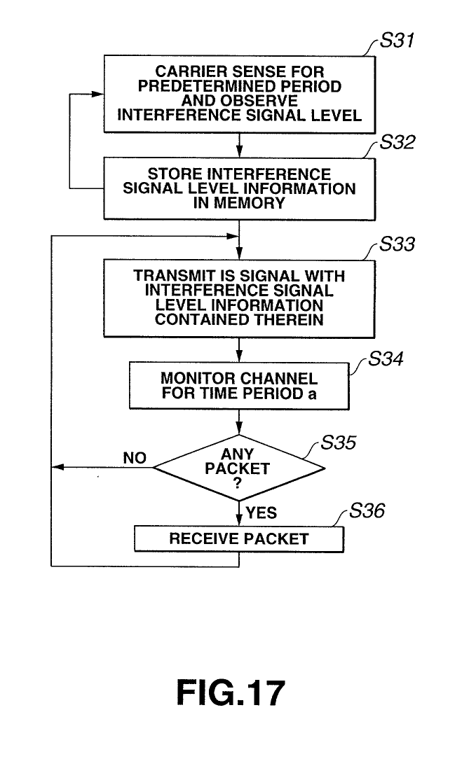

Now, the procedure that the base station 30 follows when transmitting an IS signal (or an ISA signal) will be discussed by referring to the flow chart of FIG. 17.

Firstly, the base station 30 performs a carrier sensing operation for a predetermined period of time at regular intervals to observe the signal level of the detected interference wave signal, if such a signal is ever detected (Step S31). Subsequently, the base station 30 determines the average of the signal level of the interference wave signal in the predetermined period of time and generates interference wave signal level information indicating the average value (Step S32).

Then, the base station 30 transmits an IS signal containing the interference wave signal level information to each of the terminals 40 to notify it of the fact that the communication channel is currently idle (Step S33).

Then, the base station 30 monitors the communication channel for time period a to see if any packet is sent to the communication channel (Step S34).

Subsequently, the base station 30 determines if any packet is transmitted or not during the time period a (Step S35). If no packet is transmitted, it repeats the above steps from Step S33 and retransmits an IS signal.

If a packet is transmitted during the time period a, the base station 30 receives that packet (Step S36). Then, the base station 30 determines if the packet is correctly and reliably received or not, typically referring to the error detection code of the packet, and if it is determined that the packet is correctly and reliably received, it returns to Step S33 and transmits an ISA signal after performing the estimation for still another time. If, on the other hand, the packet is not correctly and reliably received because of collision, noise or some other reason, the base station 30 transmits an IS signal in Step S33.

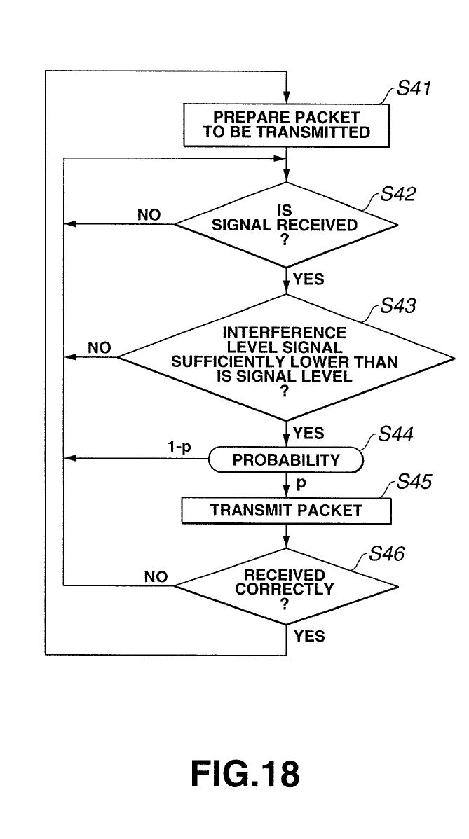

Now, the procedure to be followed by the terminals 40 when transmitting a packet will be discussed by referring to the flow chart of FIG. 18.

The terminal 40 constantly monitors the input interface to see if a request for data transmission arrives by way of the input interface or not and, if there is a request for data transmission, it prepares a packet by assembling the data to be transmitted into the packet (Step S41).

After completing the preparation of the packet for transmission, the terminal 41 waits for the IS signal transmitted from the base station 30 (Step S42).

Upon receiving the IS signal, the terminal 40 compares the signal level of the interference wave signal, if such a signal is detected, and that of the IS signal and determines if the signal level of the IS signal is sufficiently higher than that of the interference wave signal or not (Step S43). If it is determined that the signal level of the IS signal is not sufficiently higher than that of the interference wave signal, the terminal 40 leaves the packet over without transmitting it and returns to Step S42, where it waits for the next IS signal.

If it is determined that the signal level of the IS segment is sufficiently higher than that of the interference wave signal, the terminal 40 computationally determines the probability of transmission of the packet (Step S44) and, if the probability is not higher than 1−ñ, it returns to Step S42, where it waits for the reception of the next IS signal. On the other hand, the terminal 40 actually transmits the packet if the probability is not lower than ñ (Step S45).

Thereafter, the terminal 40 waits for the next IS signal and determines if an ISA signal is transmitted from the base station 30 or not (Step S46). If the terminal 40 receives an ISA signal, it returns to Step S41 and prepares the next packet to be transmitted. If, on the other hand, the terminal 40 receives not an ISA signal but an IS signal, it repeats the steps from Step S42 and retransmits the same packet.

As discussed above, of the third embodiment of radio communication system, the base station 30 performs a carrier sensing operation for a predetermined period of time to observe the reception level of the interference wave signal, if any, and transmits an IS signal containing the reception level information to the terminals. Therefore, each of the terminals can determine if the signal level of the packet to be transmitted from it is sufficiently higher than that of the interference wave signal or not so that, if the signal level of the packet is sufficiently higher than that of the interference wave signal, it can transmit the packet even though the timing of occurrence of the interference wave signal overlaps with that of transmitting the packet. Thus, each of the terminals of the third embodiment of radio communication system can determine if it can transmit a packet even though there is an interference wave signal or not and therefore it is possible to improve the efficiency of utilizing the communication channel.

The interference wave signal and the packet to be transmitted are compared simply in terms of signal level to determine if the packet can be transmitted or not in the above described third embodiment of radio communication system. However, it may be so arranged that each of the terminals can control the transmission power level in such a way that the packet is always transmitted at a signal level higher than the signal level of the interference wave signal as indicated by the information contained in the IS signal.

It may be appreciated that a packet transmitted from a terminal located close to the base station shows a signal level higher than that of a packet transmitted from a remote terminal at the base station. In other words, the terminal located close to the base station can transmits a packet with a higher probability than the remote terminal. Therefore, the information that the terminal located close to the base station can transmit a packet with a higher probability may be reflected to the probability n when determining the probability at each terminal.

[4th Embodiment]

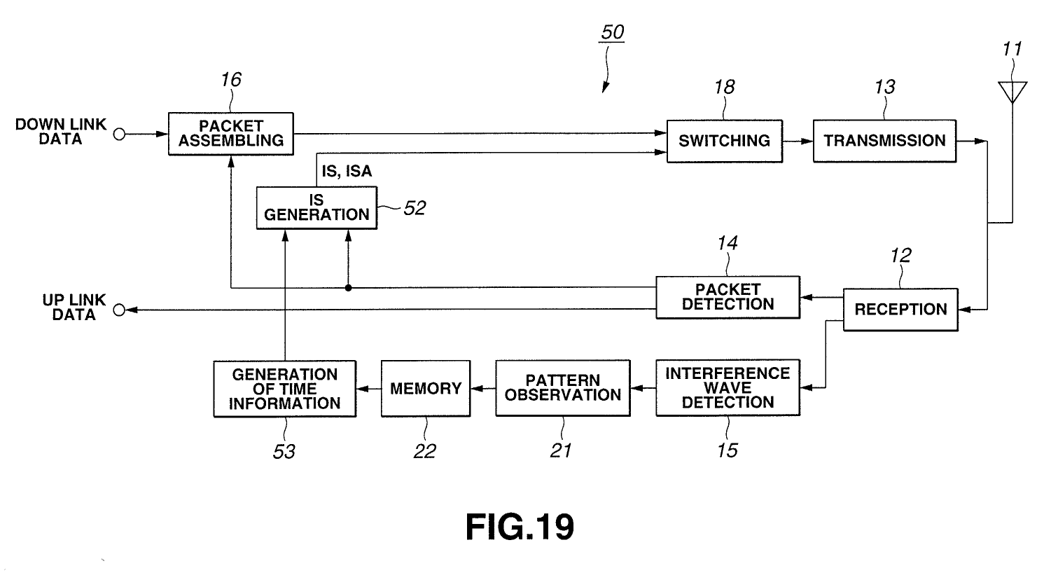

FIG. 19 is a schematic block diagram of the base station of the fourth embodiment of radio communication system. In FIG. 19, the components of the base station of the fourth embodiment that are same as those of the base station 10 of the first embodiment or those of the base station 20 of the second embodiment are denoted respectively by the same reference symbols and will not be described any further.

Referring to FIG. 19, the base station 50 comprises an antenna 11, a reception circuit 12, a transmission circuit 13, a packet detection circuit 14, an interference wave detection circuit 15, a packet assembling circuit 16, a switching circuit 18, a pattern observation circuit 21, a memory 22, a time of occurrent of interference wave estimation circuit (time information generating circuit) 53 and an IS generating circuit 52.

The pattern observation circuit 21 acquires information on the interference wave signal, if any, obtained by a carrier sensing operation of the interference wave detection circuit 15 and observes the acquired information for a predetermined period of time to find out the temporal pattern produced by the interference wave signal. For instance, if the interference wave signal is coming from a meteorological radar system, it will be a periodical signal generated at regular intervals so that the pattern observation circuit 21 finds out the cycle of generation of the interference wave signal.

The memory 22 stores the temporal pattern produced by the interference wave signal observed by the pattern observation circuit 21.

The time information generating circuit 53 estimates the time until the next interference wave signal occurs on the basis of the temporal pattern stored in the memory 22 and generates time information on the time until the occurrence of the next interference wave signal.

The IS generating circuit 52 generates an IS signal and an ISA signal. Then, the -IS generating circuit 52 outputs an IS signal at a timing when it is determined by the packet detection circuit 14 that no terminal is transmitting a packet, using the communication channel and no down link is taking place.

The IS generating circuit 52 generates and outputs an IS signal and an ISA signal containing the time information generated by the time information generating circuit 53.

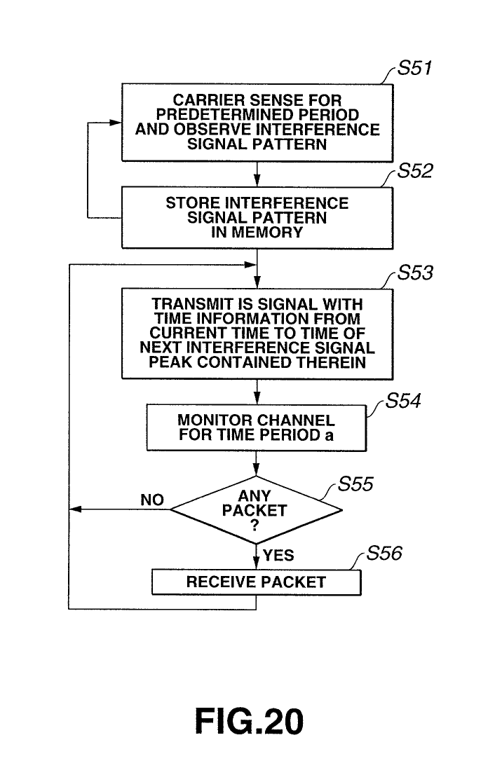

Now, the procedure that the base station 50 follows when transmitting an IS signal (or an ISA signal) will be discussed by referring to the flow chart of FIG. 20.

Firstly, the base station 50 performs a carrier sensing operation for a predetermined period of time at regular intervals to observe the temporal pattern of occurrence of the detected interference wave signal, if such a signal is ever detected (Step S51). The information on the observed temporal pattern of occurrence of an interference wave signal is stored in the memory 22 (Step S52).

Then, the base station 50 estimates the time interval from the current time until the time when the peak of the interference wave signal appears and generates time information on the estimated time interval. Then, the base station 50 transmits an IS signal containing the time information to each of the terminals and notifies it of the fact that the communication channel is currently idle.

Then, the base station 50 monitors the communication channel for time period a to see if any packet is sent to the communication channel (Step S54).

Subsequently, the base station 50 determines if any packet is transmitted or not during the time period a (Step S55). If no packet is transmitted, it repeats the above steps from Step S53 and retransmits an IS signal.

If a packet is transmitted during the time period a, the base station 50 receives that packet (Step S56). Then, the base station 50 determines if the packet is correctly and reliably received or not, typically referring to the error detection code of the packet, and if it is determined that the packet is correctly and reliably received, it returns to Step S53 and transmits an ISA signal after performing the estimation for still another time. If, on the other hand, the packet is not correctly and reliably received because of collision, noise or some other reason, the base station 50 transmits an IS signal in Step S53.

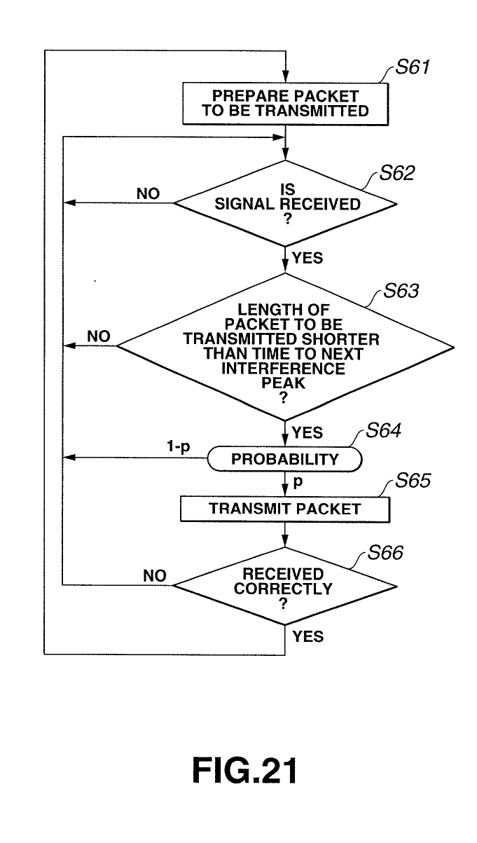

Now, the procedure to be followed by the terminals when transmitting a packet will be discussed by referring to the flow chart of FIG. 21. Note that the terminals of the fourth embodiment of radio communication system have a configuration same as those of a comparable known radio communication system and operates in a manner as described below.

The terminal constantly monitors the input interface to see if a request for data transmission arrives by way of the input interface or not and, if there is a request for data transmission, it prepares a packet by assembling the data to be transmitted into the packet (Step S61).

After completing the preparation of the packet for transmission, the terminal 60 waits for the IS signal transmitted from the base station 50 (Step S62).

Then, the terminal compares the length of the packet to be transmitted and the time length left to it until the occurrence of the next interference wave signal by referring to the time information contained in the IS signal and determines if the packet length is shorter than the time length until the occurrence of the next interference wave or not (Step S63). If it is determined that the packet length is longer, the terminal 60 leaves the packet over without transmitting it and returns to Step S62, where it waits for the next IS signal.

If it is determined that the packet length is shorter, the terminal computationally determines the probability of transmission of the packet (Step S64) and, if the probability is not higher than 1−ñ, it returns to Step S62, where it waits for the reception of the next IS signal. On the other hand, the terminal actually transmits the packet if the probability is not lower than ñ (Step S65).

Thereafter, the terminal waits for the next IS signal and determines if an ISA signal is transmitted from the base station 50 or not (Step S66). If the terminal receives an ISA signal, it returns to Step S61 and prepares the next packet to be transmitted. If, on the other hand, the terminal receives not an ISA signal but an IS signal, it repeats the steps from Step S62 and retransmits the same packet.

As discussed above, of the fourth embodiment of radio communication system, the base station 50 performs a carrier sensing operation for a predetermined period of time to generates a temporal pattern showing the timing at which an interference wave signal occurs and estimates the timing of the occurrence of the next interference wave signal. Then, it contains the information on the occurrence of the next interference wave signal in the IS signal it transmits to the terminals. Thus, the terminal trying to transmits a packet will avoid the transmission of a packet having a length longer than the time indicated by the time information and transmits a packet having a length shorter than the time indicated by the time information.

Therefore, with the fourth embodiment of radio communication system, any packet transmitted from a terminal can be safely transmitted without interfering with an interference wave signal to consequently improve the reliability of communication of the system.

While the above described first through fourth embodiments of radio communication system according to the invention are used with the ISMA method, the present invention is by no means limited to the ISMA method and can be applied to any radio communication system so long as the system is adapted to transmit an idle signal or some other signal for notifying the terminals of the availability of the communication channel from the base station.

[5th Embodiment]

Now, the fifth embodiment of radio communication system according to the invention will be described.

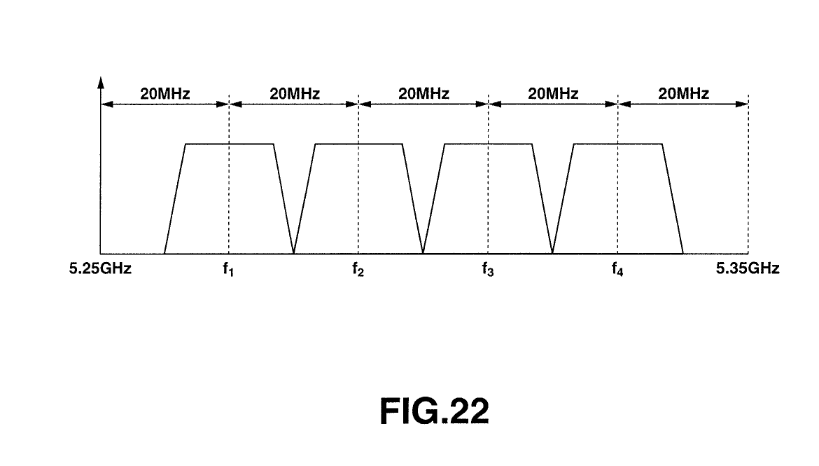

In the fifth embodiment, the frequency band available to the system is divided into a plurality of communication channels so that the frequency band may be fully exploited for the system. For instance, the frequency band between 5.25 GHz and 5.35 GHz may be divided into four frequency channels of 20 MHz for a radio communication system according to the invention as shown in FIG. 22. Each of the frequency channels obtained by dividing a frequency band will be referred to simply as frequency channel hereinafter. As pointed out earlier, the meteorological radar system uses the frequency band between 5.25 GHz and 5.35 GHz in Japan. More specifically, the Japanese meteorological radar system divides the frequency band between 5.25 GHz and 5.35 GHz by 10 MHz and allocates the narrow bands to the local meteorological radars.

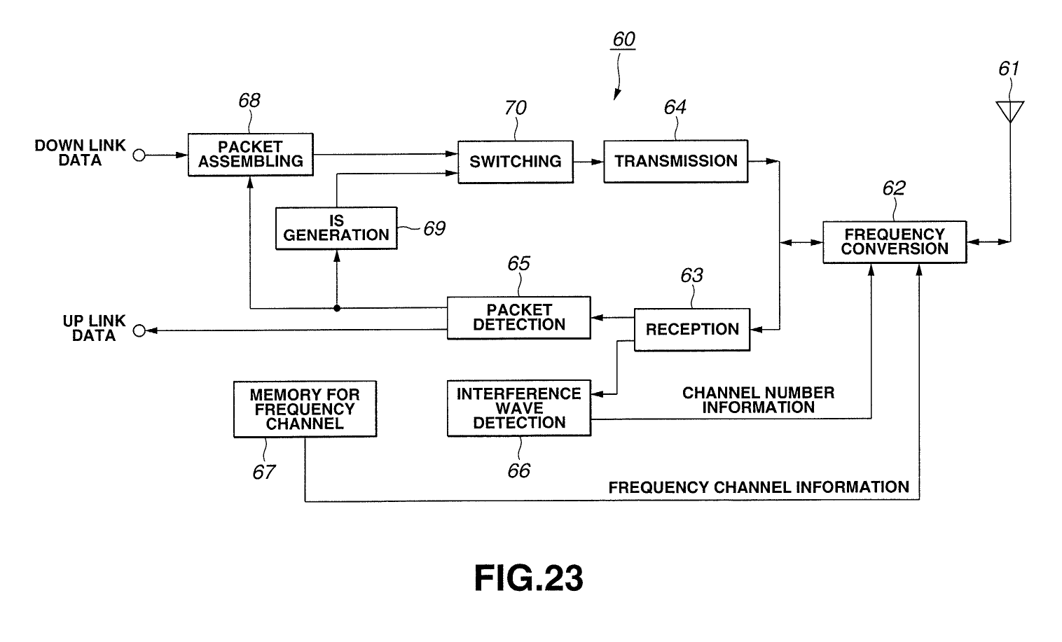

FIG. 23 is a schematic block diagram of the base station of the fifth embodiment of radio communication system according to the invention, showing its configuration.

The base station 60 comprises an antenna 61, a frequency conversion circuit 62, a reception circuit 63, a transmission circuit 64, a packet detection circuit 65, an interference wave detection circuit 66, a frequency channel memory 67, a packet assembling circuit 68, an IS generating circuit 69 and a switching circuit 70.

The antenna 61 is adapted to detect the radio wave of the communication channel to be used in the system for signal transmission/reception and also to transmit signals.

The frequency conversion circuit 62 operates for frequency conversion such as conversion from a base band signal into an RF signal or vice versa. When the frequency conversion circuit 62 transmits a signal to each of the terminals, it is fed with a base band signal from the transmission circuit 64. Then, the frequency conversion circuit converts the base band signal into an RF signal and transmits the obtained RF signal by way of the antenna 61. When, on the other hand, the frequency conversion circuit 62 receives a signal from each of the terminals, it receives the RF signal from the terminal by way of the antenna 61 and converts it into a base band signal, which is then fed to the reception circuit 63.

The frequency conversion circuit 62 appropriately changes the central frequency of the RF signal it transmits or receives. More specifically, if the frequency band between 5.25 GHz and 5.35 GHz is divided into four frequency channels, the frequency conversion circuit 62 converts the frequency of the RF signal into the central frequencies of any of the four frequency channels (e.g., f₁ and f₂ in FIG. 22). In other words, the frequency conversion circuit 62 selects the frequency channel or the frequency channels to be actually used for communications between the base station and the terminals out of the plurality of frequency channels obtained by dividing the frequency band as it changes the central frequency of the RF signal to be converted.

The frequency conversion circuit 62 selects the frequency channel or the frequency channels to be actually used for communications on the basis of the frequency channel information described in the frequency channel memory 67 and the channel number information fed from the interference wave detection circuit 66. The frequency channel information contains pieces of information, each including information on the central frequency of one of the frequency channels, information on waveform equalization and other information defined so as to correspond to a channel number to be used for specifying a particular frequency channel (e.g., numbers for specifying f₁ through f₄ in FIG. 22). The frequency channel memory 67 typically contains a table of numbers (I) that are made to corresponds to respective pieces of channel number information and the frequency channel information is stored on the table.

As an interference wave is detected by the interference wave detection circuit 66, the frequency conversion circuit 62 is supplied with channel number information that indicates the frequency channel where the detected interference wave is located and selects the frequency channel through which the base station 60 can reliably communicate with the terminals on the basis of the supplied channel number information. More specifically, the frequency conversion circuit 62 identifies a frequency channel where no interference wave is found on the basis of the supplied channel number information and selects the frequency channel to be used for communications. Then, the frequency conversion circuit 62 refers to the frequency channel memory 67 for the frequency channel information corresponding to the identified frequency channel. Thereafter, the frequency conversion circuit 62 performs a frequency converting operation of converting a base band signal into an RF signal or vice versa. Alternatively, it may be so arranged that a separate control circuit is provided for the operation of selecting a frequency channel for communications between the base station and the terminals and the frequency conversion circuit 62 operates under the control of this control circuit.

The reception circuit 63 performs operations such as demodulation of the base band signal produced by the converting operation of the frequency conversion circuit 62 and error corrections. The reception circuit 63 also receives the interference wave signals of some other systems using the frequency band that is being used by this system. For example, the reception circuit 63 typically receives radar waves of a meteorological radar system using the frequency band between 5.25 GHz and 5.35 GHz.

The transmission circuit 64 encodes and modulates error correction codes of the data to be transmitted to any of the terminals and sends them to the frequency conversion circuit 62.

The packet detection circuit 65 is fed with the data demodulated by the reception circuit 63 and determines if there is a terminal transmitting a packet to the base station by referring to the data. If there is only a single terminal that is transmitting a packet to the base station (and hence a plurality of terminals are not transmitting data simultaneously), the packet detection circuit 65 outputs the packet it detects to the outside by way of an output interface as up link data.

The interference wave detection circuit 66 performs a carrier sensing operation for a predetermined period of time on each of the frequency channels of the frequency band that the system uses to detect if the frequency channel carries an interference wave signal or not. For example, the interference wave detection circuit 66 detects if an interference wave signal such as a radar wave from the meteorological radar system using the frequency band between 5.25 GHz and 5.35 GHz is received or not. Upon detecting an interference wave signal, the interference wave detection circuit 66 determines if the detected signal shows a signal level higher than a predetermined threshold. The interference wave detection circuit 66 determines that there exists an interference wave signal when an interference wave signal showing a signal level higher than the predetermined threshold is detected, whereas it determines that there does not exist any interference wave signal when only an interference wave signal showing a signal level lower than the predetermined threshold is detected. Additionally, when it is determined that there exists an interference wave signal, the interference wave detection circuit 66 further determines the frequency band where the interference wave signal exists and notifies the frequency conversion circuit 62 of the channel number of the frequency channel where the interference wave signal exists as channel number information.

The packet assembling circuit 68 assembles the down link data input to it from the outside by way of an input interface into a packet. The packet assembling circuit 68 outputs the packet when it is determined by the packet detection circuit 65 that no other packet is being transmitted by any of the terminals (and hence the communication channel is in an idle state) and no interference wave signal is detected by the interference wave detection circuit 66.

The IS generating circuit 69 generates an IS signal and an ISA signal. An IS signal is used to indicate that the communication channel is idle and any of the terminals can use it to transmit a packet to the base station 60 by way of the communication channel. The IS generating circuit 69 outputs an IS signal at a timing when it is determined by the packet detection circuit 65 that the communication channel is not being used and no terminal is transmitting a packet and no down link is taking place and also that no interference wave signal is detected by the interference wave detection circuit 66. The timing of transmitting/receiving an IS signal, an ISA signal and a packet will be discussed in greater detail hereinafter.

The switching circuit 70 is adapted to forward the packet fed from the packet assembling circuit 68 for down link and the IS signal or the ISA signal fed from the IS generating circuit 69 to the transmission circuit 64 by way of its switching operations matched to their transmission timings.

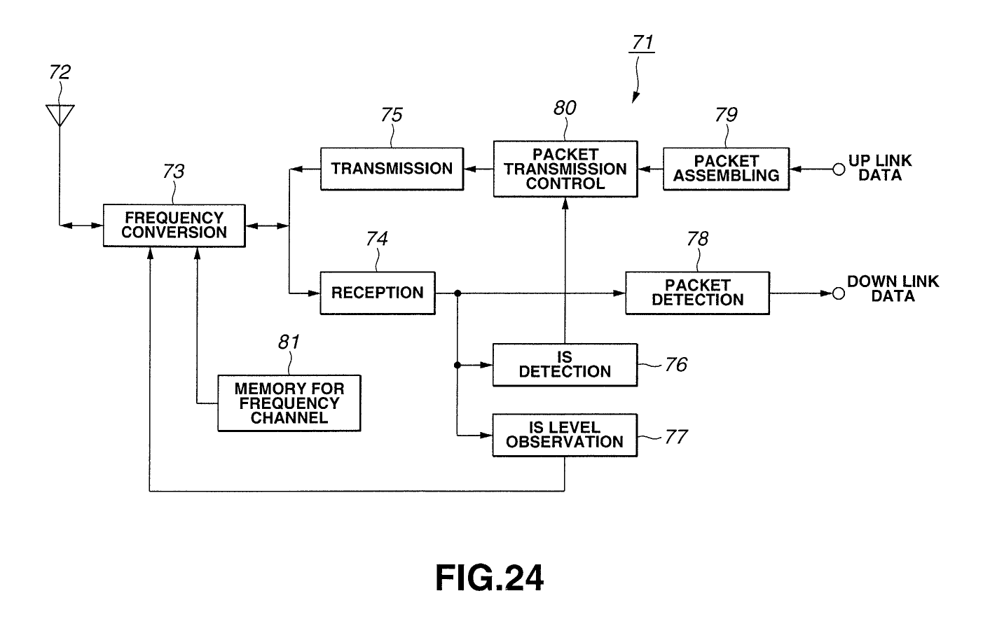

Now, the configuration of the terminals of the fifth embodiment of radio communication system will be described by referring to FIG. 24.

The terminal 71 comprises an antenna 72, a frequency conversion circuit 73, a reception circuit 74, a transmission circuit 75, an IS detection circuit 76, an IS reception level observation circuit 77, a packet detection circuit 78, a packet assembling circuit 79, a packet transmission control circuit 80 and a frequency channel memory 81.

The antenna 72 is adapted to detect the radio wave of the communication channel to be used in the system for signal transmission/reception and also to transmit signals.

The frequency conversion circuit 73 operates for frequency conversion such as conversion from a base band signal into an RF signal or vice versa. When the frequency conversion circuit 73 transmits a signal to each of the terminals, it is fed with a base band signal from the transmission circuit 75. Then, the frequency conversion circuit converts the base band signal into an RF signal and transmits the obtained RF signal by way of the antenna 72. When, on the other hand, the frequency conversion circuit 73 receives a signal from the base station, it receives an RF signal from the terminal by way of the antenna 72 and converts it into a base band signal, which is then fed to the reception circuit 74.

The frequency conversion circuit 73 appropriately changes the central frequency of the RF signal it transmits or receives. The frequency conversion circuit 73 of the terminals operates just like the frequency conversion circuit 62 of the base station.

The frequency conversion circuit 73 selects the frequency channel or the frequency channels to be actually used for communications on the basis of the frequency channel information described in the frequency channel memory 81 and the channel number information fed from the IS level observation circuit 77. The frequency channel information stored in the frequency channel memory 81 is similar to the information stored in the frequency channel memory 67 of the base station. More specifically, the frequency channel memory 81 typically contains a table of numbers (I) that are made to corresponds to respective pieces of channel number information and the frequency channel information is stored on the table.

The frequency conversion circuit 73 is fed with channel number information indicating the frequency channel to be used for communications from the IS level observation circuit 77 and selects the frequency channel to be used for communications between the terminal and the base station on the basis of the supplied channel number information.

The reception circuit 74 is adapted to operations such as demodulation and error corrections to be conducted on base band signal fed from the frequency conversion circuit 73.

The transmission circuit 75 is adapted to operations such as error corrections and modulation to be conducted on the data to be transmitted to the base station 60 and outputs the data to the frequency conversion circuit 73.

The IS detection circuit 76 detects the IS signal and the ISA signal transmitted from the base station 60.

The IS reception level observation circuit 77 performs an IS signal search operation of checking if the received IS signal is the IS signal transmitted from the base station or not, while modifying the channel number information to be fed to the frequency conversion circuit 73 periodically. The IS signal search operation of the IS reception level observation circuit 77 is conducted on all the frequency channels.

More specifically, the IS level observation circuit 77 supplies the frequency conversion circuit 73 with all the channel number information at regular intervals, when the terminal 71 is in a state ready for receiving an IS signal. With this arrangement, it is possible for the frequency conversion circuit 73 to receive the information transmitted to it by way of each and every frequency channel. Then, the IS level observation circuit 77 monitors the reception level of the signal transmitted to it and determines if the reception level of the signal is higher than a predetermined threshold or not. Then, the IS observation circuit 77 determines that an IS signal is transmitted through the frequency channel when it receives a signal showing a signal level higher than the predetermined threshold. When the terminal is brought into a state ready for transmitting a packet to the base station 60 in response to the received IS signal, it supplies the frequency conversion circuit 73 with the channel number information, identifying the frequency channel through which the IS signal is received. Then, the terminal can transmit the packet through the frequency channel same as the one through which the IS signal is transmitted to the terminal.

The IS signal search operation of the IS level observation circuit 77 is aimed to detect the frequency channel through which the base station is transmitting an IS signal. It may be so arranged that the IS signal is detected not by detecting the signal level thereof but by determining if the header of the IS signal is detected or not.

The packet detection circuit 78 identifies the packet transmitted from the base station 60 and, if the received packet is sent from the base station 60 to the terminal 71 itself, outputs it to the outside by way of an output interface as down link data.

The packet assembling circuit 79 assembles the up link data input to it from the outside by way of an input interface into a packet.

The packet transmission control circuit 80 carries out operations such as scheduling the timing of transmitting the packet fed from the packet assembling circuit 79 and determining the probability of transmitting the packet. More specifically, when the IS detection circuit 76 detects an IS signal, the packet transmission control circuit 80 determines if the communication channel is available or not and, if it is determined that the communication channel is available, it transmits the packet immediately after the reception of the IS signal. At this time, the packet transmission control circuit 80 determines the probability of transmission of the packet and actually transmits the packet if the probability is not lower than ñ, but it does not if the probability is not higher than 1−ñ.

Additionally, after the transmission of the packet, the packet transmission control circuit 80 determines if an IS or an ISA signal is detected or not. If an IS signal is detected, it indicates that the base station 60 has not received the packet transmitted last time yet so that the packet transmission control circuit 80 retransmits the packet transmitted last time. If an ISA signal is detected, it indicates that the packet transmitted last time is correctly and reliably received by the base station 60 so that the packet transmission control section 80 transmits the next packet.

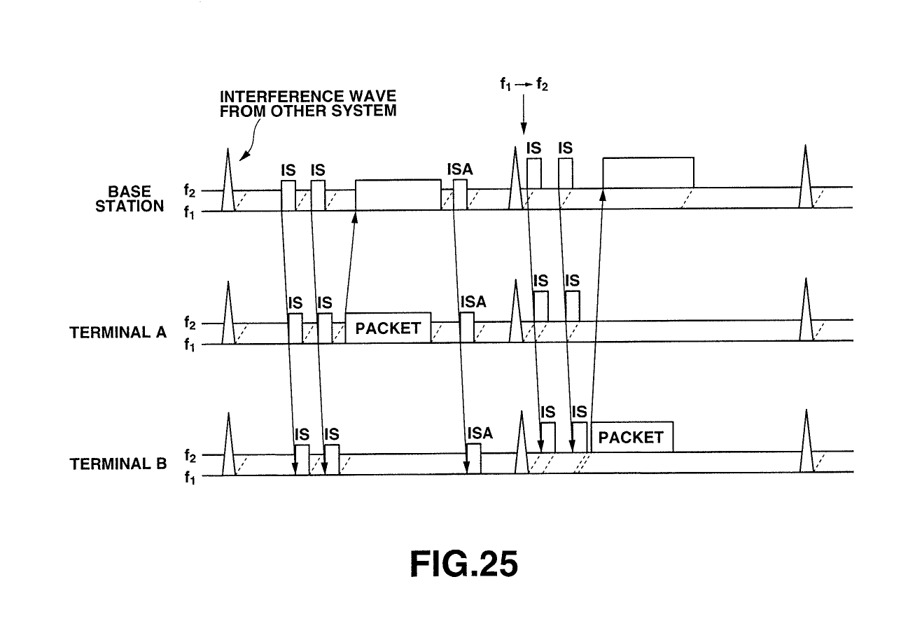

Now, the timings of transmission/reception of an IS signal, an ISA signal and a packet of the fifth embodiment of radio communication system will be discussed by referring to the timing chart of FIG. 25.

Before transmitting an IS signal, the base station 60 performs a carrier sensing operation on the frequency channel (f₁) through which it is trying to transmit the IS signal in order to find out if an interference wave signal from some other system currently exists on the frequency channel or not. If, as a result of the carrier sensing operation, a signal showing a reception level higher than a predetermined threshold is found on the frequency channel, it is determined that an interference wave signal from some other system exists on the frequency channel and the base station 60 does not transmits any IS signal. Then, the base station 60 shift the frequency channel to one having another frequency (f₁→f₂) and performs a carrier sensing operation on the newly selected frequency channel. If no signal showing a reception level higher than the predetermined threshold is observed as a result of the carrier sensing operation conducted on the new frequency channel (f₂), it is determined that no interference wave signal from some other system exists on that frequency channel.

If no interference wave signal is found on the frequency channel and there is no terminal that is currently using the frequency channel, the base station 60 transmits an IS signal.

After transmitting an IS signal, the base station 60 monitors the communication channel for delay time a (the time that elapses between the time when the base station 60 transmits an IS signal and the time when the packet transmitted from the remotest terminal in response to the IS signal arrives to the base station) and determines if a packet is transmitted from a terminal or not. If it is found that no packet is sent from a terminal during of the delay time a, the base station 60 performs another carrier sensing operation and, if no interference wave signal is found as a result of the carrier sensing operation, it transmits an IS to each of the terminals. If, on the other hand, it is found that a packet is sent from a terminal during the delay time a, the base station 60 receives the packet and then determines if the packet is correctly and reliably received or not, typically referring to the error detection code of the packet. If it is determined that the packet is not correctly and reliably received, the base station 60 performs another carrier sensing operation and subsequently transmits an IS signal to each of the terminals. If, on the other hand, it is determined that the packet is correctly and reliably received, the base station 60 performs another carrier sensing operation and transmits an ISA signal to each of the terminals.

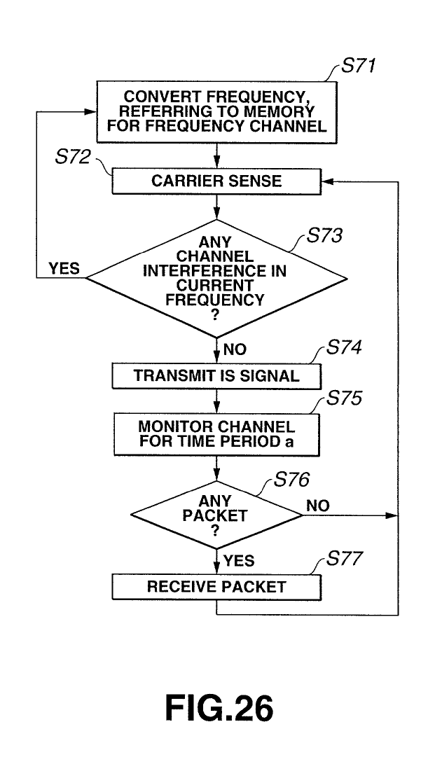

Now, the procedure that the base station 60 follows when transmitting an IS signal (or an ISA signal) will be discussed by referring to the flow chart of FIG. 26.

Firstly, the base station 60 refers to the frequency channel information described in the frequency channel memory (Step S71) and performs a carrier sensing operation on a given frequency channel (Step S72). Then, the base station 60 determines if there is an interference wave signal such as a radar wave on the frequency channel or not on the basis of the result obtained by the carrier sensing operation (Step S73). If it is determined that there is an interference wave signal, the processing operation returns to Step S71, where the base station 60 selects another frequency channel and performs a carrier sensing operation on the frequency channel.

If, on the other hand, it is determined that there is not any interference wave signal, the base station 60 subsequently transmits an IS signal (Step S74).

Then, the base station 60 monitors the communication channel for time period a to see if any packet is transmitted to the communication channel (Step S75).

Subsequently, the base station 60 determines if any packet is transmitted or not during the time period a (Step S76). If no packet is transmitted, it repeats the above steps from Step S72, performs another carrier sensing operation and retransmits an IS signal.

If a packet is transmitted during the time period a, the base station 60 receives that packet (Step S77). Then, the base station 60 determines if the packet is correctly and reliably received or not, typically referring to the error detection code of the packet, and if it is determined that the packet is correctly and reliably received, the base station 60 makes arrangements so that it transmits not an IS signal but an ISA signal next time. If, on the other hand, the packet is not correctly and reliably received because of collision, noise or some other reason, the base station 60 makes arrangements so that it transmits not an ISA signal but an IS signal next time. Upon completing the processing operation for receiving the packet, the base station 60 returns to Step S72 and repeats the above steps.

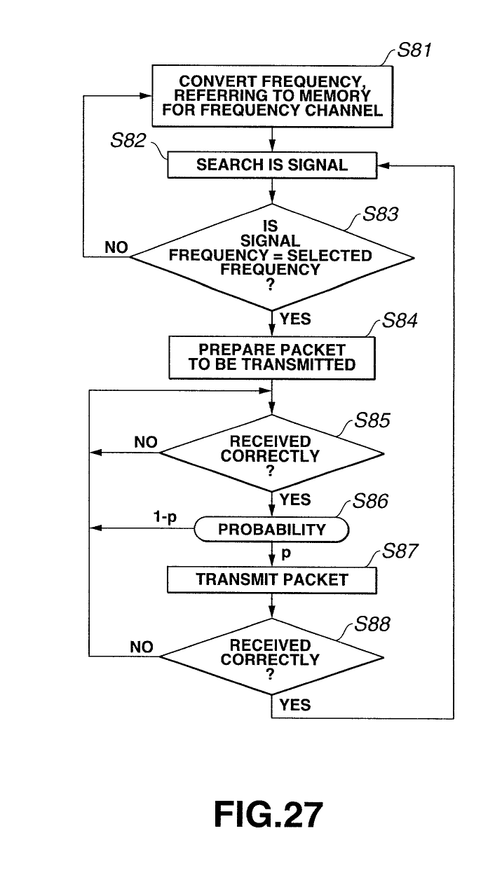

Now, the procedure to be followed by the terminals 71 when transmitting a packet will be discussed by referring to the flow chart of FIG. 27.

Firstly, the terminal 71 refers to the frequency channel information described in the frequency channel memory (Step S81) and performs an IS signal search operation on all the frequency channels that the system can use (Step S82). If an IS signal is detected on a frequency channel as a result of the IS signal search operation, the terminal 71 determines that the base station 60 is using the frequency channel. If, on the other hand, no IS signal is detected on a frequency channel, the terminal 71 determines that the base station 60 is not using the frequency channel and returns to Step S81, where it selects another frequency channel and performs an IS signal search operation on that frequency channel (Step S83).

Meanwhile, the terminal 71 constantly monitors the input interface to see if a request for data transmission arrives by way of the input interface or not and, if there is a request for data transmission, it prepares a packet by assembling the data to be transmitted into the packet (Step S84).

After completing the preparation of the packet for transmission, the terminal 71 waits for the IS signal transmitted from the base station 60 (Step S85).

Upon receiving the IS signal, the terminal 71 computationally determines the probability of transmission of the packet (Step S86) and, if the probability is not higher than 1−ñ, it leaves the packet over without transmitting it and returns to Step S85, where it waits for the reception of the next IS signal. On the other hand, the terminal actually transmits the packet if the probability is not lower than ñ (Step S87).

Thereafter, the terminal waits for the next IS signal and determines if an ISA signal is transmitted from the base station 60 or not (Step S88). If the terminal receives an ISA signal, it returns to Step S84 and prepares the next packet to be transmitted. If, on the other hand, the terminal receives not an ISA signal but an IS signal, it repeats the steps from Step S85 and retransmits the same packet.

Note that the IS signal search operation from Step S81 to Step S83 in the flow chart of FIG. 27 is conducted constantly whenever the terminal 71 is in a standby state, waiting for an IS signal. Therefore, the operation of receiving an IS signal in Step S85 is completed when an IS signal is detected as a result of the processing operation for receiving an IS signal from Step S81 to Step S83.

As described above, the fifth embodiment of radio communication system according to the invention is adapted to divide an available frequency band into a plurality of frequency channels to fully exploit the frequency band for the system. Therefore, the base station of the fifth embodiment of radio communication system performs a carrier sensing operation firstly on a given frequency channel selected from the plurality of frequency channels to see if an interference wave signal exists on that frequency channel. If an interference wave signal exists, the base station of the system selects another one of the frequency channels to transmits an IS signal. With this arrangement, the base station of the fifth embodiment of radio communication system can transmits an IS signal without the risk of interfering with some other system. In other words, if there is some other system that uses the same communication channel, the fifth embodiment of radio communication system minimizes the risk of interfering with that system and also the risk of being affected by that system to degrade the performance of itself.

Each of the terminals of this fifth embodiment of radio communication system performs an IS signal search operation on each and every frequency channel when it is in a standby state, waiting for receiving an IS signal. Then, the terminal uses the frequency channel through which it received an IS signal in order to transmits a packet to the base station. In other words, the packet is transmitted by way of a frequency channel through which the terminal received an IS signal without fail and no IS signal is transmitted through that frequency channel if an interference wave signal exists there. Therefore, the terminal does not transmit any packet through that frequency channel. Differently stated, terminals of any comparable known system can be used for the fifth embodiment of radio communication system without the risk of being affected by some other system to degrade the performance of this embodiment of radio communication system.

Additionally, the transmission of an IS signal of this fifth embodiment of radio communication system is not suspended but carried out by using some other frequency channel available to the system to realize a high communication efficiency.

While the terminals perform an IS signal search operation on each and every frequency channel (e.g., each and every one of the frequency channels f₁ through f₄) in the fifth embodiment of radio communication system, it may alternatively be so arranged that one or more than one candidate frequency channels (e.g., f₁ and f₄ out of f₁ through f₄) are selected in advance and described in the IS signal transmitted to the terminals. With this arrangement, the load of the IS signal search operation of the terminals will be alleviated.

[6th Embodiment]

Now, the sixth embodiment of radio communication system according to the invention will be described.

As in the case of the above described fifth embodiment, the frequency band available to the sixth embodiment of radio communication system is divided into a plurality of communication channels so that the frequency band may be fully exploited for the system. The components of this embodiment that are same as their counterparts are denoted respectively by the same reference symbols and will not be described any further.

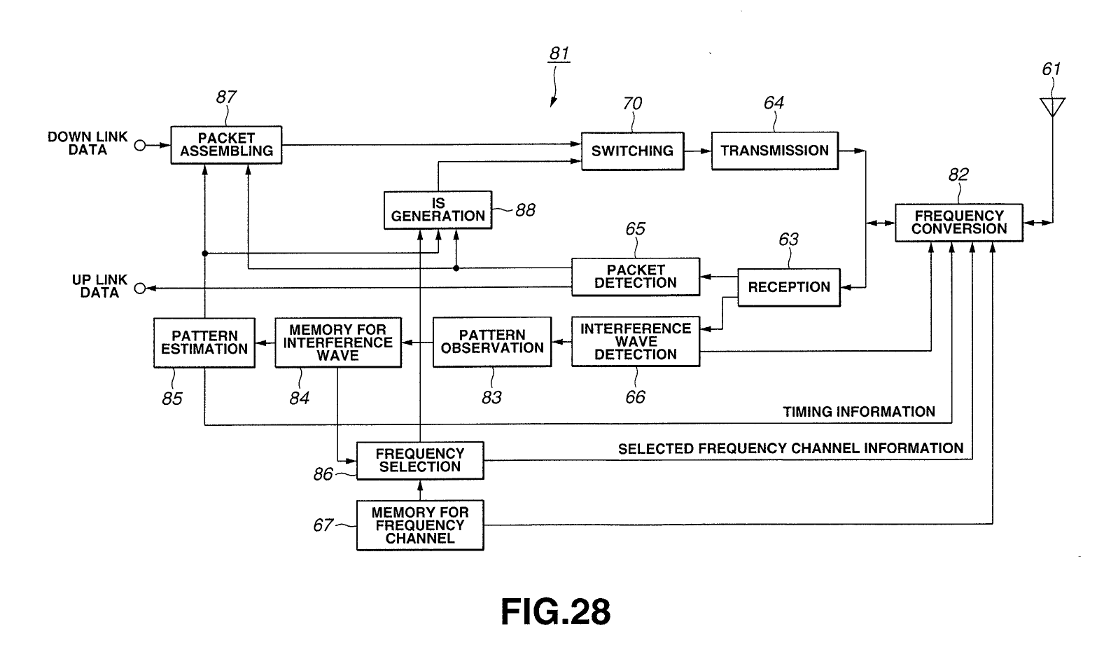

FIG. 28 is a schematic block diagram of the base station of the sixth embodiment of radio communication system according to the invention, showing its configuration.

The base station 81 comprises an antenna 61, a reception circuit 63, a transmission circuit 64, a packet detection circuit 65, an interference wave detection circuit 66, a frequency channel memory 67, a switching circuit 70, a frequency conversion circuit 82, a pattern observation circuit 83, an interference wave memory 84, a pattern estimation circuit 85, a frequency selection circuit 86, a packet assembling circuit 87 and an IS generating circuit 88.

The frequency conversion circuit 82 operates for frequency conversion such as conversion from a base band signal into an RF signal or vice versa. When the frequency conversion circuit 82 transmits a signal to each of the terminals, it is fed with a base band signal from the transmission circuit 64. Then, the frequency conversion circuit converts the base band signal into an RF signal and transmits the obtained RF signal by way of the antenna 61. When, on the other hand, the frequency conversion circuit 82 receives a signal from each of the terminals, it receives an RF signal from the terminal by way of the antenna 61 and converts it into a base band signal, which is then fed to the reception circuit 63.

The frequency conversion circuit 82 appropriately changes the central frequency of the RF signal that transmits or receives. More specifically, if the frequency band between 5.25 GHz and 5.35 GHz is divided into four frequency channels, the frequency conversion circuit 82 converts the frequency of the RF signal into the central frequencies of any of the four frequency channels. In other words, the frequency conversion circuit 82 selects the frequency channel or the frequency channels to be actually used for communications between the base station and the terminals out of the plurality of frequency channels obtained by dividing the frequency band as it changes the central frequency of the RF signal to be converted.

Like the frequency conversion circuit 62 of the firth embodiment, the frequency conversion circuit 82 selects a frequency channel to be used for communications on the basis of the frequency channel information described in the frequency channel memory 67 and the channel number information fed from the interference wave detection circuit 66.

Furthermore, the frequency conversion circuit 82 switches the frequency channel to be used for communications according to the timing information fed from the pattern estimation circuit 85. The information on the frequency channel to be newly selected is contained in the frequency channel selection information output from the frequency selection circuit 86.

The pattern observation circuit 83 acquires information on the interference wave signal, if any, obtained by a carrier sensing operation of the interference wave detection circuit 66 and observes the acquired information for a predetermined period of time on each and every frequency channel to find out the temporal pattern produced by the interference wave signal in each and every frequency channel. For instance, if the interference wave signal is coming from a meteorological radar system, it will be a periodical signal generated at regular intervals so that the pattern observation circuit 83 finds out the cycle of generation of the interference wave signal.

The interference wave memory 84 stores the temporal pattern produced by the interference wave signal as observed by the pattern observation circuit 83.

The pattern estimation circuit 85 estimates the possibility of occurrence of an interference wave after a predetermined period of time from now and the timing of the next generation of the interference wave signal on the basis of the temporal pattern (such as the periodicity of interference) stored in the interference wave memory 84 and the current time. The pattern estimation circuit 85 generates timing information indicating the timing immediately before the occurrence of the next interference wave on the frequency channel that is being used for communication on the basis of its estimation and supplies it to the frequency conversion circuit 82.

The frequency selection circuit 86 selects a frequency channel where no interference wave exists by referring to the occurrence pattern of interference wave signal of each and every frequency channel as described in the interference wave memory 84. Then, the frequency selection circuit 86 reads out the frequency channel information on the selected frequency channel from the frequency channel memory 67 and supplies it to the frequency conversion circuit 82.

The packet assembling circuit 87 assembles the down link data input from the outside by way of an input interface into a packet. Then, the packet assembling circuit 87 outputs the packet, using one of the communication channels assigned to the system, when it is determined that no other packet is being transmitted by any of the terminals, (and hence the communication channel is in an idle state). Furthermore, the packet assembling circuit 87 outputs the packet when it is determined that no interference wave signal is generated during the transmission of the packet on the basis of the estimated information of the pattern estimation circuit 85.

The IS generating circuit 88 generates an IS signal and an ISA signal. The IS generating circuit 88 outputs the IS signal that generates at a timing when it is determined by the packet detection circuit 65 that no terminal is transmitting a packet, using the communication channel and no down link is taking place, and no interference wave signal is detected by the interference wave detection circuit 66. Additionally, the IS generating circuit 88 inserts channel specifying information for notifying the terminals of the frequency channel through which the next IS signal is transmitted into the IS signal. The IS generating circuit 88 generates the channel specifying information by referring to the channel number information of the frequency channel that is selected next time by the frequency selection circuit 86. The channel specifying information may include not only the information on the frequency channel through which the next IS signal is transmitted but also the information indicating the time and the frequency channel selected for transmitting an IS signal after a predetermined period of time from now if such information is available.

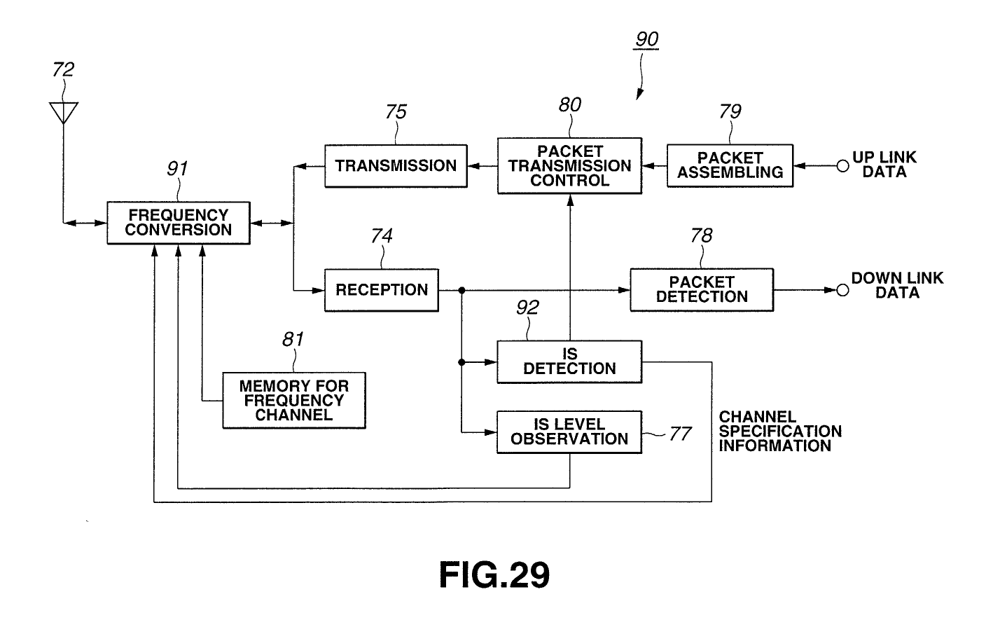

Now, the configuration of the terminals of the sixth embodiment of radio communication system will be described by referring to FIG. 29.

The terminal 90 comprises an antenna 72, a reception circuit 74, a transmission circuit 75, an IS level observation circuit 77, a packet detection circuit 78, a packet assembling circuit 79, a packet transmission control circuit 80, a frequency channel memory 81, a frequency conversion circuit 91 and an IS detection circuit 92.

The frequency conversion circuit 91 operates for frequency conversion such as conversion from a base band signal into an RF signal or vice versa. When the frequency conversion circuit 91 transmits a signal to each of the terminals, it is fed with a base band signal from the transmission circuit 75. Then, the frequency conversion circuit converts the base band signal into an RF signal and transmits the obtained RF signal by way of the antenna 72. When, on the other hand, the frequency conversion circuit 91 receives a signal from the base station, it receives an RF signal from the terminal by way of the antenna 72 and converts it into a base band signal, which is then fed to the reception circuit 74.

The frequency conversion circuit 91 appropriately changes the central frequency of the RF signal that transmits or receives. The frequency conversion circuit 91 of the terminals operates just like the frequency conversion circuit 82 of the base station.

Immediately after the start of operation of the system, the frequency conversion circuit 91 selects the frequency channel or the frequency channels to be actually used for communications on the basis of the frequency channel information described in the frequency channel memory 67 and the channel number information fed from the interference wave detection circuit 66 just like the frequency conversion circuit 62 of the fifth embodiment.

On the other hand, during the operation of the system, the frequency conversion circuit 91 selects the frequency channel specified by the channel specifying information fed from the IS detection circuit 92 and switches the frequency channel to be used for communications at the time when the transmission of the up link packet responding to the received IS signal is over (or after the reception of the IS signal if no up link packet is transmitted).

The IS detection circuit 92 detects the IS signal and the ISA signal sent from the base station 81. Additionally, the IS detection circuit 92 extracts the channel specifying information contained in the IS signal and the ISA signal and detects the frequency channel through which the next IS signal and the next ISA signal are transmitted.

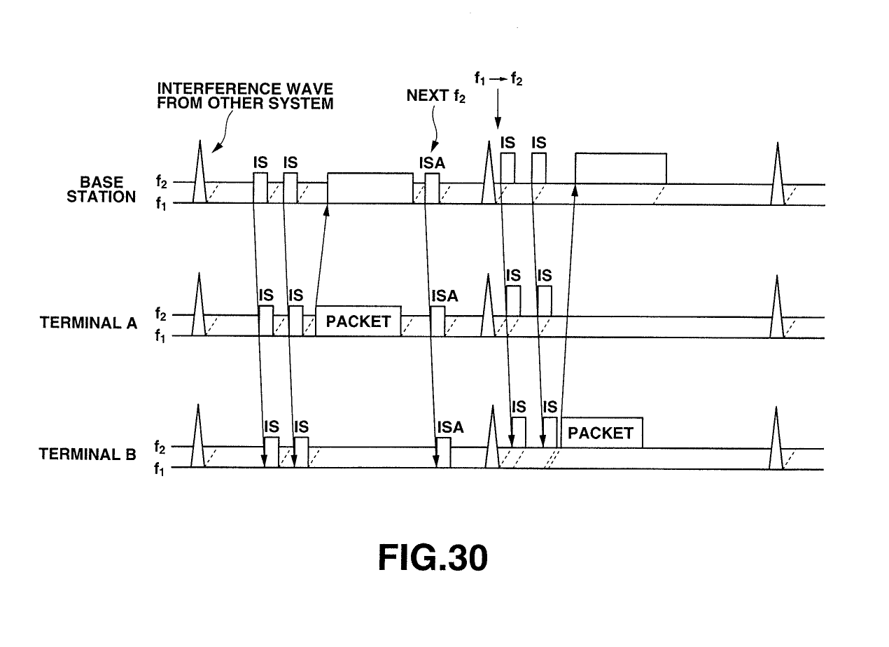

Now, the timings of transmission/reception of an IS signal, an ISA signal and a packet of the sixth embodiment of radio communication system will be discussed by referring to the timing chart of FIG. 30.

The base station 81 performs a carrier sensing operation for a predetermined period of time at regular intervals and observes the temporal pattern indicating the timing of occurrence of an interference wave signal. The information on the observed temporal pattern indicating the timing of occurrence of an interference wave signal is then stored in the memory.

When transmitting an IS signal, firstly, the base station 81 selects the frequency channel that is free from any interference wave signal by referring to the temporal pattern stored in the memory before transmitting the IS signal. Then, the base station 81 estimates on the assumption that the IS signal is transmitted now if an interference wave signal is produced between now and the time when a packet transmitted in response to the IS signal arrives it. If it is estimated that a collision of the IS signal and/or the packet from the terminal and the interference wave signal will highly probably occur, the base station 81 transmits the IS signal immediately preceding the IS signal that highly probably collides with the interference wave signal, containing in it the channel specifying information on the shift of frequency channel (from f₁ to f₂) for the transmission of the next IS signal. Therefore, the base station 81 transmits the next IS signal (that is expected to highly probably collides with the interference wave signal) by way of some other frequency channel. If no shift of frequency channel is expected, the base station 81 transmits the channel specifying information, containing in it the information of specifying the frequency channel that is currently used.

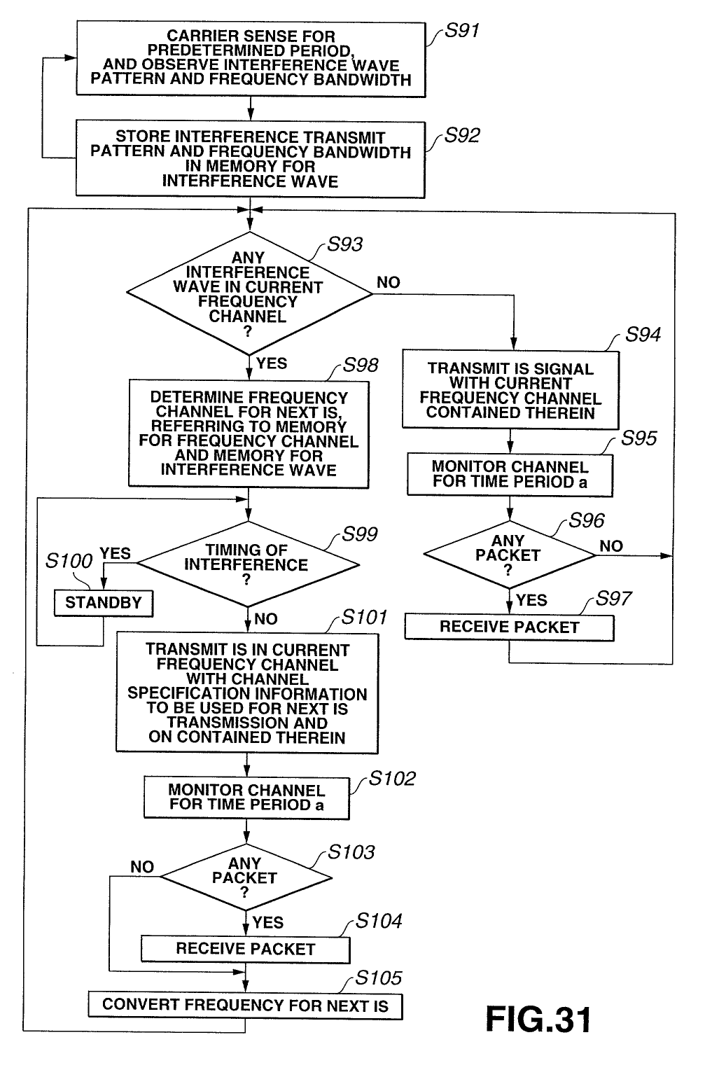

Now, the procedure that the base station 81 follows when transmitting an IS signal (or an ISA signal) will be discussed by referring to the flow chart of FIG. 31.

Firstly, the base station 81 performs a carrier sensing operation for a predetermined period of time at regular intervals to observe the temporal pattern of occurrence of the detected interference wave signal, if such a signal is ever detected (Step S91). The information on the observed temporal pattern of occurrence of an interference wave signal is stored in the memory (Step S92).

Then, the bases station 81 determines if an interference wave signal exists on the currently selected frequency channel or not (Step S93).

If it is determined that no interference wave signal exists on the currently selected frequency channel, the operation proceeds to Step S94, where the base station 81 describes the currently selected frequency channel in the channel specifying information and transmits an IS signal.

Then, the base station 81 monitors the communication channel for time period a to see if any packet is sent to the communication channel (Step S95).

Subsequently, the base station 81 determines if any packet is transmitted or not during the time period a (Step S96). If no packet is transmitted, it repeats the above steps from Step S93.

If a packet is transmitted during the time period a, the base station 81 receives the packet (Step S96). Then, the base station 81 determines if the packet is correctly and reliably received or not, typically referring to the error detection code of the packet, and if it is determined that the packet is correctly and reliably received, it makes arrangements so as to transmit not an IS signal but an ISA signal next time. If, on the other hand, the packet is not correctly and reliably received because of collision, noise or some other reason, the base station 81 makes arrangements so as to transmit not an ISA signal but an IS signal next time. When the reception of the packet is over, it returns to Step S93 to repeat the process.

If, on the other hand, it is determined in Step S93 that there exists an interference wave signal on the currently selected frequency channel, the base station 81 determines the frequency channel to be used for transmitting the next IS signal, referring to the information stored in the frequency channel memory 81 and the interference wave memory 84 in such a way that no interference wave signal may be found on the newly selected frequency channel (Step S98).

Subsequently, the base station 81 estimates if an interference wave signal is produced between now and the time when a packet transmitted in response to the IS signal arrives it on the basis of the result obtained by the carrier sensing operation (Step S99). If it is estimated that an interference wave signal will be produced, the base station 81 stays in a standby state until an interference wave signal is produced (Step S100) and then returns to Step S99, where it carries out the estimation once again.

If, on the other hand, it is estimated that an interference wave signal will not be produced, the base station 81 subsequently transmits an IS signal through the currently selected frequency channel, containing in it the channel specifying information for specifying the frequency channel to be used for transmitting the next IS signal (Step S101).

Then, the base station 81 monitors the communication channel for time period a to see if any packet is sent to the communication channel (Step S102).

Subsequently, the base station 81 determines if any packet is transmitted or not during the time period a (Step S102). If no packet is transmitted, it proceeds to Step S105, where it makes arrangements so as to transmit not an ISA signal but an IS signal next time.

If a packet is transmitted during the time period a, the base station 81 receives that packet (Step S104). Then, the base station 81 determines if the packet is correctly and reliably received or not, typically referring to the error detection code of the packet, and if it is determined that the packet is correctly and reliably received, it makes arrangements so as to transmit not an IS signal but an ISA signal next time. If, on the other hand, the packet is not correctly and reliably received because of collision, noise or some other reason, the base station 81 makes arrangements so as to transmit not an ISA signal but an IS signal next time. When the reception of the packet is over, the base station 81 switches the frequency to be used (from f₁→f₂) and repeats the steps from Step S93.

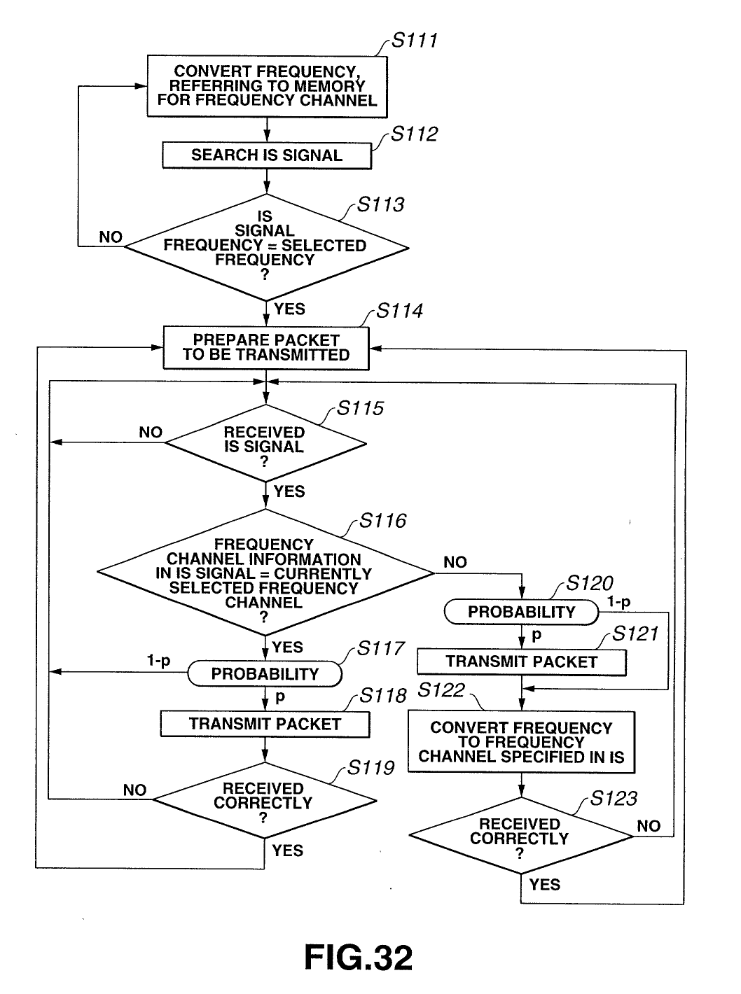

Now, the procedure to be followed by the terminals 90 when transmitting a packet will be discussed by referring to the flow chart of FIG. 32.

Firstly, the terminal 90 refers to the frequency channel information described in the frequency channel memory (Step S111) and performs an IS signal search operation on all the frequency channels that the system can use (Step S112). If an IS signal is detected on a frequency channel as a result of the IS signal search operation, the terminal 90 determines that the base station 81 is using the frequency channel. If, on the other hand, no IS signal is detected on a frequency channel, the terminal 90 determines that the base station 81 is not using the frequency channel and returns to Step S111, where it selects another frequency channel and performs an IS signal search operation on that frequency channel (Step S113).

Meanwhile, the terminal 90 constantly monitors the input interface to see if a request for data transmission arrives by way of the input interface or not and, if there is a request for data transmission, it prepares a packet by assembling the data to be transmitted into the packet (Step S114).

After completing the preparation of the packet for transmission, the terminal 90 waits for the IS signal transmitted from the base station 81 (Step S115).

Upon receiving the IS signal, the terminal 90 determines if the frequency channel described in it agrees with the currently selected frequency channel or not (Step S116).

If they agree with each other, after the reception of the IS signal, the terminal computationally determines the probability of transmission of the packet (Step S117) and, if the probability is not higher than 1−ñ, it leaves the packet over without transmitting it and returns to Step S115, where it waits for the reception of the next IS signal. On the other hand, the terminal actually transmits the packet if the probability is not lower than ñ (Step S118).

Thereafter, the terminal waits for the next IS signal and determines if an ISA signal is transmitted from the base station 81 or not (Step S119). If the terminal receives an ISA signal, it returns to Step S114 and prepares the next packet to be transmitted. If, on the other hand, the terminal receives not an ISA signal but an IS signal, it repeats the steps from Step S115 and retransmits the same packet.

If, on the other hand, it is determined that the frequency channel described in the channel specifying information does not agree with the currently selected frequency channel, after the reception of the IS signal, the terminal computationally determines the probability of transmission of the packet (Step S120) and, if the probability is not higher than 1−ñ, it leaves the packet over without transmitting it and returns to Step S115, where it waits for the reception of the next IS signal. On the other hand, the terminal actually transmits the packet if the probability is not lower than ñ (Step S121).

Subsequently, the terminal switches the reception frequency to that of the frequency channel described in the channel specifying information contained in the received IS signal (Step S122).

Thereafter, the terminal waits for the next IS signal and determines if an ISA signal is transmitted from the base station 81 or not (Step S123). If the terminal receives an ISA signal, it returns to Step S114 and prepares the next packet to be transmitted. If, on the other hand, the terminal receives not an ISA signal but an IS signal, it repeats the steps from Step S115 and retransmits the same packet.

As described above, the sixth embodiment of radio communication system according to the invention is adapted to divide an available frequency band into a plurality of frequency channels to fully exploit the frequency band for the system. Additionally, the sixth embodiment of radio communication system is adapted to estimate the timing of occurrence of an interference wave signal and shifts the frequency channel when the timing of occurrence of an interference wave signal comes so that the base station transmits an IS signal through the newly selected frequency channel. Therefore, if there is some other system that uses the same communication channel, the sixth embodiment of radio communication system minimizes the risk of interfering with that system and also the risk of being affected by that system to degrade the performance of itself.

Additionally, since the sixth embodiment of radio communication system is adapted to estimate the timing of occurrence of an interference wave signal, it can send information on the time of shifting the frequency channel and on the newly selected frequency channel to the terminals before the shift actually takes place. With this arrangement of notifying the terminals of the expected shift of frequency channel, the load of the IS signal search operation of the terminals will be alleviated.

Note that the sixth embodiment of radio communication system is adapted to transmit channel specifying information on the expected shift of frequency channel to the terminals after containing it in an IS signal, it may alternatively be so arranged that the information is contained in an ordinary down link packet and transmitted to the terminals.

What is claimed is:

1. A radio communication device adapted to radio communications using a predetermined frequency band, said device comprising:
an information signal detection means for detecting an information signal transmitted from some other radio communication device;
an idle signal transmission means for transmitting an idle signal, notifying other radio communication devices of the idle state of said predetermined frequency band of non-detection of an information signal transmitted from some other radio communication device as detected by said information signal detection means;
an interference wave signal detection means for detecting any interference wave signal being transmitted by way of said predetermined frequency band; and
said idle signal transmission means being adapted to avoid transmission of said idle signal upon detection of an interference wave signal.

2. A radio communication device adapted to radio communications using a predetermined frequency band, said device comprising:
an information signal detection means for detecting an information signal transmitted from some other radio communication device;
an idle signal transmission means for transmitting an idle signal, notifying other radio communication devices of the idle state of said predetermined frequency band of non-detection of an information signal transmitted from some other radio communication device as detected by said information signal detection means;
an interference wave signal detection means for detecting any interference wave signal being transmitted by way of said predetermined frequency band;
an interference wave signal transmission pattern estimation means for estimating the temporal pattern of transmission of the interference wave signal as detected by said interference wave signal detection means; and
said idle signal transmission means being adapted to computationally determine the timing for the idle signal and the information signal transmitted from some other radio communication device in response to said idle signal not overlapping the (time of) transmission of said interference wave signal and transmit said idle signal at the computationally determined timing.

3. The radio communication device according to claim 2, wherein said interference wave signal detection means detects any interference wave signal before the start of operation of the device.

4. The radio communication device according to claim 2, wherein said interference wave signal detection means detects any interference wave signal at regular intervals during the operation of the device.

5. The radio communication device according to claim 2, wherein said interference wave signal detection means detects any interference wave signal during the device is not operating for communications.

6. The radio communication device according to claim 2, wherein,
when an interference wave signal is detected, said idle signal transmission means avoids the transmission of said idle signal and computationally determines the timing for the idle signal and the information signal to be transmitted from some other radio communication device in response to the idle signal not overlapping the transmission period of said interference wave signal so as to transmit said idle signal at the determined timing.

7. A radio communication device adapted to radio communications using a predetermined frequency band, said device comprising:
an information signal detection means for detecting an information signal transmitted from some other radio communication device;
an idle signal transmission means for transmitting an idle signal, notifying other radio communication devices of the idle state of said predetermined frequency band of non-detection of an information signal transmitted from some other radio communication device as detected by said information signal detection means;
an interference wave signal detection means for detecting the signal level any interference wave signal being transmitted by way of said predetermined frequency band; and
said idle signal transmission means being adapted to transmit said idle signal by containing therein level information indicating the signal level of said interference wave signal.

8. A radio communication device adapted to radio communications using a predetermined frequency band, said device comprising:
an information signal detection means for detecting an information signal transmitted from some other radio communication device;
an idle signal transmission means for transmitting an idle signal, notifying other radio communication devices of the idle state of said predetermined frequency band of non-detection of an information signal transmitted from some other radio communication device as detected by said information signal detection means;
an interference wave signal detection means for detecting any interference wave signal being transmitted by way of said predetermined frequency band;
an interference wave signal transmission pattern estimation means for estimating the temporal pattern of transmission of the interference wave signal as detected by said interference wave signal detection means; and
said idle signal transmission means being adapted to transmit said idle signal by containing therein time length information indicating the time length available for forwarding the transmission of said information signal from some other radio communication means as transmitted in response to said idle signal without overlapping with the interference wave signal, if any, on the basis of the pattern estimated by said interference wave signal transmission pattern estimation means.

9. A radio communication device adapted to radio communications using a predetermined frequency band, said device comprising:
an idle signal reception means for receiving an idle signal transmitted from some other radio communication device and indicating the availability of said predetermined frequency range;
an information signal transmission means for transmitting an information signal to said some other radio communication means having transmitted said idle signal according to the timing of receiving said idle signal;
said idle signal containing level information indicating the signal level of any interference wave signal being transmitted by way of said predetermined frequency range; and
said information signal transmission means being adapted to transmit said information signal to its base station, indicating the detectable signal level as determined on the basis of said signal level of the interference wave signal.

10. A radio communication device adapted to radio communications using a predetermined frequency band, said device comprising:
an idle signal reception means for receiving an idle signal transmitted from some other radio communication device and indicating the availability of said predetermined frequency range;
an information signal transmission means for transmitting an information signal to said some other radio communication means having transmitted said idle signal according to the timing of receiving said idle signal;
said idle signal containing time length information indicating the time length available for signal transmission without overlapping with the interference wave signal, if any, being transmitted by way of said predetermined frequency range; and
said information signal transmission means being adapted to transmit an information signal on the time length available for signal transmission directed to its base station as determined on the basis of said time length information.

11. A radio communication system comprising a base station and one ore more than one terminal communication devices for radio communications between said base station and said one or more than one terminal communication devices, using a predetermined frequency band;
said base station having:
an information signal detection means for detecting an information signal transmitted from said terminal communication device or any of said terminal communication devices;
an idle signal transmission means for transmitting an idle signal, notifying said one or more than one other terminal communication devices of the idle state of said predetermined frequency band of non-detection of an information signal transmitted from said terminal communication device or any of said terminal communication devices as detected by said information signal detection means;
an interference wave signal detection means for detecting any interference wave signal being transmitted by way of said predetermined frequency band;
said idle signal transmission means being adapted to avoid transmission of said idle signal upon detection of an interference wave signal; and
said terminal communication device or each of said terminal communication devices being adapted to transmit an information signal according to the timing of receiving said idle signal transmitted from said base station.

12. A radio communication system comprising a base station and one ore more than one terminal communication devices for radio communications between said base station and said one or more than one terminal communication devices, using a predetermined frequency band;
said base station having:
an information signal detection means for detecting an information signal transmitted from said terminal communication device or any of said terminal communication devices;
an idle signal transmission means for transmitting an idle signal, notifying said one or more than one other terminal communication devices of the idle state of said predetermined frequency band of non-detection of an information signal transmitted from said terminal communication device or any of said terminal communication devices as detected by said information signal detection means;
an interference wave signal detection means for detecting the level of any interference wave signal being transmitted by way of said predetermined frequency band;
an interference wave signal transmission pattern estimation means for estimating the temporal pattern of transmission of the interference wave signal as detected by said interference wave signal detection means;
said idle signal transmission means being adapted to computationally determine the timing for the idle signal and the information signal transmitted from said terminal communication device or any of said terminal communication devices in response to said idle signal not overlapping the (time of) transmission of said interference wave signal on the basis of the pattern estimated by said interference wave signal transmission pattern estimation means and transmit said idle signal at the computationally determined timing; and
said terminal communication device or each of said terminal communication devices being adapted to transmit an information signal to said base station according to the timing of receiving said idle signal transmitted from said base station.

13. A radio communication system comprising a base station and one ore more than one terminal communication devices for radio communications between said base station and said one or more than one terminal communication devices, using a predetermined frequency band;
said base station having:
an information signal detection means for detecting an information signal transmitted from said terminal communication device or any of said terminal communication devices;
an idle signal transmission means for transmitting an idle signal, notifying said one or more than one other terminal communication devices of the idle state of said predetermined frequency band of non-detection of an information signal transmitted from said terminal communication device or any of said terminal communication devices as detected by said information signal detection means;
an interference wave signal detection means for detecting the level of any interference wave signal being transmitted by way of said predetermined frequency band;
said idle signal transmission means being adapted to transmit said idle signal by containing therein level information indicating the signal level of said detected interference wave signal; and
said terminal communication device or each of said terminal communication devices being adapted to transmit an information signal on the detectable signal level to said base station according to the timing of receiving said idle signal transmitted from said base station and the level information contained in said idle signal.

14. A radio communication system comprising a base station and one ore more than one terminal communication devices for radio communications between said base station and said one or more than one terminal communication devices, using a predetermined frequency band;
said base station having:
an information signal detection means for detecting an information signal transmitted from said terminal communication device or any of said terminal communication devices;
an idle signal transmission means for transmitting an idle signal, notifying said one or more than one other terminal communication devices of the idle state of said predetermined frequency band of non-detection of an information signal transmitted from said terminal communication device of any of said terminal communication devices as detected by said information signal detection means;
an interference wave signal detection means for detecting the level of any interference wave signal being transmitted by way of said predetermined frequency band;
an interference wave signal transmission pattern estimation means for estimating the temporal pattern of transmission of the interference wave signal as detected by said interference wave signal detection means;
said idle signal transmission means being adapted to transmit said idle signal by containing therein time length information indicating the time length available for forwarding the transmission of said information signal from said terminal communication device or any of said terminal communication devices as transmitted in response to said idle signal without overlapping with the interference wave signal, if any, on the basis of the pattern estimated by said interference wave signal transmission pattern estimation means; and
said terminal communication device or each of said terminal communication devices being adapted to transmit an information signal on the time length available for signal transmission to the base station according to the timing of receiving said idle signal transmitted from said base station and the time length information contained in said idle signal.

15. A radio communication method for radio communications between a base station and one or more than one terminal communication devices, using a predetermined frequency band;
said base station detecting any interference wave signal being transmitted by way of said predetermined frequency band;
said base station transmitting an idle signal to said one or more than one other terminal communication devices, notifying the availability of said predetermined frequency band, avoiding said detected interference wave signal, if any; and
said terminal communication device or each of said terminal communication devices transmitting an information signal according to the timing of receiving said idle signal transmitted from said base station.

16. A radio communication method for radio communications between a base station and one or more than one terminal communication devices, using a predetermined frequency band;
said base station detecting any interference wave signal being transmitted by way of said predetermined frequency band;
said base station estimating the temporal pattern of transmission of the detected interference wave signal, if any, on the basis of said interference wave signal;
said base station computationally determining the timing for the idle signal and the information signal transmitted from said terminal communication device or any of said terminal communication devices in response to said idle signal not overlapping the (time of) transmission of said interference wave signal on the basis of the estimated pattern and transmitting said idle signal at the computationally determined timing; and
said terminal communication device or each of said terminal communication devices transmitting an information signal to said base station according to the timing of receiving said idle signal transmitted from said base station.

17. A radio communication method for radio communications between a base station and one or more than one terminal communication devices, using a predetermined frequency band;
said base station detecting the level of any interference wave signal being transmitted by way of said predetermined frequency band;
said base station transmitting an idle signal, containing therein level information indicating the signal level of the detected interference wave signal, if any, to said one or more than one terminal communication devices; and
said terminal communication device or each of said terminal communication devices transmitting an information signal on the detectable signal level to said base station according to the timing of receiving said idle signal and the level information contained in said idle signal.

18. A radio communication method for radio communications between a base station and one or more than one terminal communication devices, using a predetermined frequency band;
said base station detecting any interference wave signal being transmitted by way of said predetermined frequency band;
said base station estimating the temporal pattern of transmission of the interference wave signal, if any, as detected by said interference wave signal detection means;
said base station transmitting an idle signal, containing the time length information indicating the available time length of said predetermined frequency band for forwarding the transmission of an information signal from said terminal communication device or any of said terminal communication devices without overlapping with the interference wave signal, if any, on the basis of the estimated pattern to said terminal component device; and
said terminal communication device or each of said terminal communication devices transmitting an information signal on the time length available for signal transmission to the base station according to the timing of receiving said idle signal and the time length information contained in said idle signal.

19. A radio communication device adapted to radio communications using a plurality of frequency channels, said device comprising:
an information signal detection means for detecting an information signal transmitted from some other radio communication device;
an idle signal transmission means for transmitting an idle signal by using one of said plurality of frequency channels for notifying said some other radio communication device of the availability of said frequency channel; and
an interference wave signal detection means for detecting any interference wave signal being transmitted by way of any of said frequency channels; and said idle signal transmission means being adapted to transmit said idle signal, using a frequency channel free from the detected interference wave signals, if any.

20. The radio communication device according to claim 19, wherein said idle signal transmission means contains channel limiting information for limiting the frequency channels that can be used for transmitting an idle signal out of said plurality of frequency channels in said idle signal.

21. The radio communication device according to claim 19, further comprising:
an interference wave signal transmission pattern estimation means for estimating the temporal pattern of transmission of an interference wave signal on each of the frequency channels; and
said idle signal transmission means switches the frequency channel for the transmission of said idle signal on the estimated pattern so as to make said idle signal and the information signal transmitted from said some other radio communication device in response to said idle signal not overlap the transmission of said interference wave.

22. The radio communication device according to claim 21, wherein said idle signal transmission means contains switch time information for switching the frequency channel to be used for the transmission of said idle signal and channel specifying information for specifying the channel to be used after the switch in said idle signal.

23. The radio communication device according to claim 21, further comprising:
an information signal transmission means for transmitting an information signal to some other radio communication device; and
said information signal transmission means contains switch information for switching the frequency channel to be used for the transmission of said idle signal and channel specifying information for specifying the channel to be used after the switch in said idle signal.

24. A radio communication device adapted to radio communications using a plurality of frequency channels, said device comprising:
an idle signal reception means for receiving an idle signal transmitted from some other radio communication device by using one of said plurality of frequency channels to notify the availability of said frequency channel;
an information signal transmission means for transmitting an information signal to said some other radio communication device, or the origin of said idle signal, according to the timing of receiving said idle signal; and
said information signal transmission means being adapted to transmit said information signal, using the frequency channel used for the transmission of said idle signal out of said plurality of frequency channels.

25. The radio communication device according to claim 24, wherein
said idle signal contains channel limiting information for limiting the frequency channels that can be used for transmitting an idle signal out of said plurality of frequency channels; and
said idle signal reception means performs a search operation only on the frequency channels limited by said channel limiting information.

26. The radio communication device according to claim 24, wherein
said idle signal contains switch time information for switching the frequency channel to be used for the transmission of said idle signal and channel specifying information for specifying the channel to be used after the switch; and
said idle signal reception means switches to the frequency channel specified by said channel specifying information when the time specified by said switch time information comes.

27. The radio communication device according to claim 24, further comprising:
an information signal reception means for receiving an information signal transmitted from some other radio communication device;
said information signal contains information for switching the frequency channel to be used for the transmission of said idle signal and channel specifying information for specifying the channel to be used after the switch; and
said idle signal reception means switches to the frequency channel specified by said channel specifying information when the time specified by said switch time information comes.

28. A radio communication system comprising a base station and one ore more than one terminal communication devices for radio communications between said base station and said one or more than one terminal communication devices, using a plurality of frequency channels;
said base station having:
an information signal detection means for detecting an information signal transmitted from said terminal communication device or any of said terminal communication devices;
an idle signal transmission means for transmitting an idle signal to said terminal communication device, using any of said plurality of frequency channels, to notify said terminal communication device of the availability of said frequency channel;
an interference wave signal detection means for detecting any interference wave signal being transmitted by way of any of said frequency channels; and
said idle signal transmission means being adapted to transmit said idle signal, using a frequency channel free from the detected interference wave signals, if any,
said terminal communication device or devices having:
an idle signal reception means for receiving said idle signal;
an information signal transmission means for transmitting an information signal to said base station, or the origin of said idle signal, according to the timing of receiving said idle signal; and
said information signal transmission means being adapted to transmit said information signal, using the frequency channel used for the transmission of said idle signal out of said plurality of frequency channels.

29. The radio communication system according to claim 28, wherein
said idle signal transmission means of said base station contains channel limiting information for limiting the frequency channels that can be used for transmitting an idle signal out of said plurality of frequency channels in said idle signal; and
said idle signal reception means of said terminal communication device performs a search operation only on the frequency channels limited by said channel limiting information to receive said idle signal.

30. The radio communication system according to claim 28, wherein
said base station further has an interference wave signal transmission pattern estimation means for estimating the temporal pattern of transmission of an interference wave signal on each of the frequency channels on the basis of the detected interference wave signal and said idle signal transmission means switches the frequency channel for the transmission of said idle signal on the estimated pattern so as to make said idle signal and the information signal transmitted from said some other radio communication device in response to said idle signal not overlap the transmission of said interference wave and transmits said idle signal;
said terminal communication devices further has an idle signal reception means for receiving said idle signal and an information signal transmission means for transmitting an information signal to said base station of the origin of said idle signal in response to the timing of reception of said idle signal; and
said information transmission means being adapted to transmit said information signal, using the frequency channel used for the transmission of said idle signal out of the plurality of frequency channels.

31. The radio communication system according to claim 30, wherein
said idle signal transmission means contains switch time information for switching the frequency channel to be used for the transmission of said idle signal and channel specifying information for specifying the channel to be used after the switch in said idle signal; and
said idle signal reception means switches to the frequency channel specified by said channel specifying information when the time specified by said switch time information comes.

32. The radio communication system according to claim 30, wherein
said base station further has an information signal transmission means for transmitting an information signal to said terminal communication devices and said information signal transmission means contains switch time information for switching the frequency channel to be used for the transmission of said idle signal and channel specifying information for specifying the channel to be used after the switch in said information signal; and
said terminal communication devices further have an information signal reception means for receiving the information signal transmitted from said base station and switches to the frequency channel specified by said channel specifying information when the time specified by said switch time information comes.

33. A radio communication method for radio communications between a base
station and one or more than one terminal communication devices, using a plurality of frequency channels;
said base station detecting any interference wave signal being transmitted by way of any of said frequency channels;
said base station transmitting an idle signal, using a frequency channel free from the detected interference wave signals, if any, to notify said terminal communication device or devices of the availability of said frequency channel; and
said terminal communication device or devices being adapted to transmit said information signal, using the frequency channel used for the transmission of said idle signal out of said plurality of frequency channels.

34. The radio communication method according to claim 33, wherein
said idle signal transmission means of said base station contains channel limiting information for limiting the frequency channels that can be used for transmitting an idle signal out of said plurality of frequency channels in said idle signal; and
said idle signal reception means of said terminal communication device performs a search operation only on the frequency channels limited by said channel limiting information to receive said idle signal.

35. The radio communication method according to claim 33, wherein
said base station estimates the temporal pattern of transmission of an interference wave signal on each of the frequency channels on the basis of the detected interference wave signal and switches the frequency channel for the transmission of said idle signal on the estimated pattern so as to make said idle signal and the information signal transmitted from said some other radio communication device in response to said idle signal not overlap the transmission of said interference wave and transmits said idle signal; and
said terminal communication devices transmits said information signal to said base station, using the frequency channel used for the transmission of said idle signal out of the plurality of frequency channels.

36. The radio communication method according to claim 35, wherein
said base station contains switch time information for switching the frequency channel to be used for the transmission of said idle signal and channel specifying information for specifying the channel to be used after the switch in said idle signal; and
said terminal communication device switches to the frequency channel specified by said channel specifying information when the time specified by said switch time information comes.

37. The radio communication method according to claim 35, wherein
said base station contains switch time information for switching the frequency channel to be used for the transmission of said idle signal and channel specifying information for specifying the channel to be used after the switch in said information signal; and
said terminal communication devices switches to the frequency channel specified by said channel specifying information to receive said idle signal when the time specified by said switch time information comes.
